(19) United States
(12) Patent Application Publication
(10) Pub. No.: US 2023/0256693 A1
(43) Pub. Date: Aug. 17, 2023

(54) PLASTIC LENS, METHOD FOR MANUFACTURING PLASTIC LENS, AND MOLDING APPARATUS FOR MANUFACTURING PLASTIC LENS

(71) Applicant: Samsung Electro-Mechanics Co., Ltd., Gyeonggi-do (KR)

(72) Inventors: Dong-soo HAM, Suwon-si (KR); Hyun-ji KIM, Suwon-si (KR); Joong-Eok KIM, Suwon-si (KR); Hyun-Joong LEE, Suwon-si (KR)

(73) Assignee: Samsung Electro-Mechanics Co., Ltd., Gyeonggi-do (KR)

(21) Appl. No.: 18/014,105

(22) PCT Filed: Jun. 17, 2021
(86) PCT No.: PCT/KR2021/007581

§ 371 Date: Dec. 30, 2022

(30) Foreign Application Priority Data
Sep. 18, 2020 (KR) 10-2020-0120888

(51) Int. Cl. B29D 11/00; B29B 11/08; B29B 11/12

(52) U.S. Cl. CPC B29D 11/00548; B29B 11/08; B29B 11/12; B29D 11/00413; B29L 2011/0016

(57) ABSTRACT

A method of manufacturing a plastic lens includes first heating of a lens preform, disposing the lens preform in a molding apparatus, second heating of the lens preform, pressing the lens preform with the molding apparatus, and cooling the molding apparatus.

### TECHNICAL FIELD

The present disclosure relates to a plastic lens, a method for manufacturing a plastic lens, and a molding apparatus for manufacturing a plastic lens.

### BACKGROUND ART

Generally, a lens used in a camera module of a portable electronic device such as a smartphone may be a plastic lens, and such a plastic lens may be manufactured by injection molding.

An injection molding apparatus may have a cavity corresponding to a lens shape, and a plastic lens may be manufactured by injecting molten resin into the cavity.

However, in the case of the injection molding method, there may be residual stress in a gate portion for supplying molten resin to the cavity, which may deteriorate optical performance of the lens.

Also, there may be a difference in the speed at which molten resin flows in different portions of the cavity, and accordingly, flow marks or weld lines may be formed in the lens, which may deteriorate optical performance of the lens.

The above information is presented as background information only to assist with an understanding of the present disclosure. No determination has been made, and no assertion is made, as to whether any of the above might be applicable as prior art with regard to the disclosure.

### DISCLOSURE

### Technical Problem

An aspect of the present disclosure is to provide a plastic lens having improved optical performance, a method for manufacturing a plastic lens and a molding apparatus for manufacturing a plastic lens.

### Technical Solution

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a method of manufacturing a plastic lens includes first heating of a lens preform, disposing the lens preform in a molding apparatus, second heating of the lens preform, pressing the lens preform with the molding apparatus, and cooling the molding apparatus.

The first heating of the lens preform may include moving the lens preform, and heating the lens preform to a temperature within a first temperature range.

The temperature within the first temperature range may be equal to or lower than a glass transition temperature of the lens preform.

The temperature within the first temperature range may be Tg−50° C. to Tg, where Tg is the glass transition temperature of the lens preform.

The lens preform may be heated to the temperature within the first temperature range while moving to the molding apparatus.

The lens preform may be moved to the molding apparatus while being adsorbed and heated by a moving device comprising an adsorption portion and a heating portion.

The first heating of the lens preform may further include seating the lens preform in a preheating stage and heating the lens preform before the lens preform is disposed in the molding apparatus.

The disposing the lens preform in the molding apparatus may include seating the lens preform in a molding portion of the molding apparatus, and the molding apparatus may be heated to a temperature within a first temperature range.

The second heating of the lens preform may include forming a cavity in which the lens preform is disposed by combining a first molding apparatus and a second molding apparatus of the molding apparatus, and heating the molding apparatus to a temperature within a second temperature range.

The temperature within the second temperature range may be equal to or higher than the glass transition temperature of the lens preform.

The temperature within the second temperature range may be Tg to Tg+100° C., where Tg is the glass transition temperature of the lens preform.

The heating the molding apparatus to the temperature within the second temperature range may include increasing the temperature of the lens preform to be higher than the first heating temperature by heating the molding apparatus.

The heating the molding apparatus to the temperature within the second temperature range may include further increasing a temperature of the cavity to be higher than a temperature of an other portion of the molding apparatus.

The heating the molding apparatus to the temperature within the second temperature range may include heating a pin core of the first molding apparatus and a pin core of the second molding apparatus which form the cavity, through a heating portion disposed in the molding apparatus.

The heating portion may include a heating wire, and the method may further include applying power to the heating wire.

In the pressing the lens preform with the molding apparatus, when a temperature of the lens preform is equal to or higher than the glass transition temperature, the lens preform may be pressed.

In the pressing the lens preform with the molding apparatus, the lens preform may be pressed while being heated to a temperature within a second temperature range equal to or higher than the glass transition temperature of the lens preform.

In the cooling the molding apparatus, the molding apparatus may be cooled to a temperature less than the glass transition temperature of the lens preform.

The cooling the molding apparatus may include supplying a fluid to the molding apparatus.

The method may further include preparing the lens preform, wherein the lens preform may be formed to have a shape different from a shape of a cavity of the molding apparatus.

The preparing the lens preform may include injection molding the lens preform using a thermoplastic resin.

The preparing the lens preform may include applying heat to a thermoplastic resin in a pellet state and pressing the thermoplastic resin.

The preparing the lens preform may include drying a thermoplastic resin in a pellet state by freezing the thermoplastic resin, powdering the thermoplastic resin by pulverizing the thermoplastic resin, and pressing the powdered thermoplastic resin.

The preparing the lens preform may include laminating and pressing a plurality of films or sheets of a thermoplastic resin material.

In another general aspect, a molding apparatus for molding a plastic lens includes a first molding apparatus including a first core portion and a first body portion accommodating the first core portion, and a second molding apparatus including a second core portion and a second body portion accommodating the second core portion, wherein the first molding apparatus and the second molding apparatus oppose each other, and one of the first molding apparatus and the second molding apparatus is configured to be movable, wherein each of the first core portion and the second core portion includes at least one pin core having a molding portion corresponding to a shape of a lens to be manufactured, and wherein each of the first body portion and the second body portion includes a heating portion configured to generate heat and a flow path portion configured to be provided with a fluid.

The heating portion may include a first heating portion for heating the first body portion and the second body portion, and the first heating portion may include an accommodating portion penetrating one side of the first body portion and the second body portion, and a heating member disposed in the accommodating portion.

The heating member may include a conductive housing, an insulating core disposed in the conductive housing, and a wound coil disposed on the insulating core, and the wound coil may have a region in which a winding space is narrower than that of an other region.

The accommodating portion and the flow path portion may be connected to each other.

The accommodating portion may have a length in one direction, and the flow path portion may have a length in an other direction intersecting the accommodating portion.

The flow path portion may include a first flow path connected to one side of the accommodating portion, and a second flow path connected to an other side of the accommodating portion, wherein the first flow path may be connected to the second flow path by the accommodating portion.

The first flow path may have one side configured to be opened and closed, and an other side to be closed, the second flow path may have the one side closed, and the other side configured to be opened and closed, and one of the one side of the first flow path and the other side of the second flow path is an inlet configured to flow the fluid in, and the other is an outlet configured to discharge the fluid.

A direction in which the fluid is configured to flow in the first body portion may be opposite to a direction in which the fluid is configured to flow in the second body portion.

The heating portion may include a first heating portion for heating the first body portion and the second body portion, and the first heating portion may include a coil portion, and a plate spaced apart from the coil portion and having conductivity.

The heating portion may include a first heating portion for heating the first body portion and the second body portion, and a second heating portion for heating the first core portion and the second core portion.

A heating temperature of the second heating portion may be higher than a heating temperature of the first heating portion.

A heating temperature of the first heating portion may be equal to or less than a glass transition temperature of a material of the lens to be manufactured, and a heating temperature of the second heating portion may be equal to or higher than the glass transition temperature.

A heating temperature of the first heating portion may be from a temperature lower than the glass transition temperature by 50° C. to the glass transition temperature, and a heating temperature of the second heating portion may be from the glass transition temperature to a temperature higher than the glass transition temperature by 100° C.

The second heating portion may include a heating wire disposed around the first core portion and around the second core portion.

Each of the first core portion and the second core portion may include a plurality of pin cores, and the heating wire may include a plurality of heating wires corresponding to the pin cores, respectively.

In another general aspect, a plastic lens includes an optical portion refracting light, and a flange portion extending from a circumference of the optical portion, wherein the flange portion includes a protrusion protruding from one surface of the flange portion, and wherein T_max/T_min>3.0 is satisfied, where T_max is a greatest thickness of the optical portion, and T_min is a lowest thickness of the optical portion.

A diameter of the plastic lens may be 10 mm or greater.

The protrusion may extend in an optical axis direction from an edge of one surface of the flange portion.

A length of the protrusion in the optical axis direction may be 100 μm or less, and a width of the protrusion in a direction perpendicular to the optical axis may be 80 μm or less.

A width of the protrusion in a direction perpendicular to the optical axis may change in a circumferential direction.

The protrusion may be continuously disposed along the circumferential direction on the edge of the one surface of the flange portion.

The protrusion may include a plurality of protrusions spaced apart from each other, and a sum of circumferences of the plurality of protrusions in the circumferential direction may be 80% or greater of a circumference of the flange portion.

The protrusion may extend in a direction perpendicular to an optical axis from one surface of the flange portion.

A lens assembly may include a lens barrel including an inner space to accommodate one or more lenses, and openings configured to pass light, one or more lenses disposed in the inner space along an optical axis configured to receive incident light and emit refracted light, wherein the one or more lenses may include the plastic lens, and the one or more lenses may include a first group disposed toward an object side and a second group disposed toward an image side of the lens barrel.

In another general aspect, a plastic lens includes an optical portion refracting light, a flange portion extending from a circumference of the optical portion, and a protrusion protruding from at least one of the optical portion and the flange portion, wherein the optical portion includes a first edge and a second edge disposed on opposite sides with reference to an optical axis and including an arc shape, and a third edge and a fourth edge connecting the first edge to the second edge, and disposed on opposite sides with reference to the optical axis, wherein a shortest distance passing through the optical axis between the third edge and the fourth edge is shorter than a shortest distance passing through the optical axis between the first edge and the second edge, and wherein the flange portion includes a first flange portion extending from the first edge and a second flange portion extending from the second edge.

The protrusion may protrude from one surface of the first flange portion and one surface of the second flange portion.

The protrusion may protrude from the third edge and the fourth edge.

A lens assembly may include a lens barrel including an inner space to accommodate one or more lenses, and openings configured to pass light, one or more lenses disposed in the inner space along an optical axis configured to receive incident light and emit refracted light, wherein the one or more lenses may include the plastic lens secured to one or more of the lens barrel and another lens by the flange portion.

In another general aspect, a method of manufacturing a lens includes heating a lens preform to a first temperature, disposing the lens preform heated to the first temperature in a molding apparatus, heating the lens preform to a second temperature in the molding apparatus, pressing the lens preform heated to the second temperature into a lens, and cooling the molding apparatus.

The method may further include moving the lens preform wherein the first temperature may be in a range between 50° C. below a glass transition temperature of the lens preform and the glass transition temperature of the lens preform.

The lens preform may be heated to the first temperature while moving the lens preform to the molding apparatus.

The disposing the lens preform in the molding apparatus may include disposing the lens preform in a cavity between a first molding apparatus and a second molding apparatus of the molding apparatus, and heating the lens preform to the second temperature may include heating the molding apparatus to a temperature within a range between the glass transition temperature of the lens preform and 100° C. above the glass transition temperature.

The heating the lens preform to the second temperature in the molding apparatus may include locally heating the molding apparatus adjacent the lens preform to a temperature within a range between the glass transition temperature of the lens preform and 100° C. above the glass transition temperature and independently generally heating the molding apparatus.

The heating the lens preform to the first temperature may include heating a plurality of lens preforms to the first temperature, the disposing the lens preform heated to the first temperature in the molding apparatus may include disposing the plurality of lens preforms heated to the first temperature in the molding apparatus, the heating the lens preform to the second temperature in the molding apparatus may include heating the plurality of lens preforms to the second temperature, and the pressing the lens preform heated to the second temperature into the lens may include pressing the plurality of lens preforms heated to the second temperature into a plurality of lenses at the same time.

In another general aspect, a molding apparatus for molding a lens includes a first molding apparatus comprising one or more first molding portions corresponding to a shape of a lens to be manufactured, a second molding apparatus comprising one or more second molding portions corresponding to a shape of a lens to be manufactured opposing the first molding portions and configured to be movable, wherein each of the first molding apparatus and the second molding apparatus comprises a heating portion configured to generate heat and a flow path portion configured to flow a fluid.

The first molding apparatus may include a first core portion comprising one or more pin cores having the first molding portion and a first body portion accommodating the first core portion, and the second molding apparatus may include a second core portion comprising one or more pin cores having the second molding portion and a second body portion accommodating the first core portion.

The heating portion may include an accommodating portion penetrating sides of the first molding apparatus and the second molding apparatus, and a heating member disposed in the accommodating portion.

In another general aspect, a pressed lens includes an optical portion configured to refract light, a flange portion extending from an outer periphery of the optical portion, and a pressed protrusion protruding from one of the flange portion and the optical portion, wherein the pressed protrusion extends in one of parallel to an optical axis direction of the optical portion and perpendicular to the optical axis direction.

The pressed lens may be substantially free of flow mark, weld line, and birefringence.

T_max/T_min may be greater than 3.0, where T_max is a greatest thickness of the optical portion, and T_min is a lowest thickness of the optical portion.

The optical portion may include a first edge and a second edge disposed on opposite sides with reference to an optical axis and each comprising an arc shape, and a third edge and a fourth edge connecting the first edge to the second edge, and disposed on opposite sides with reference to the optical axis, a shortest distance passing through the optical axis between the third edge and the fourth edge may be shorter than a shortest distance passing through the optical axis between the first edge and the second edge, and the flange portion may include a first flange portion extending from the first edge and a second flange portion extending from the second edge.

A lens assembly may include a lens barrel comprising an inner space to accommodate one or more lenses, and openings configured to pass light, and one or more lenses disposed in the inner space along an optical axis configured to receive incident light and emit refracted light, wherein the one or more lenses may include the pressed lens.

Other features and aspects will be apparent from the following detailed description, the drawings, and the claims.

### Advantageous Effects

By using the plastic lens, a method for manufacturing the plastic lens, and a molding apparatus for manufacturing the plastic lens according to the example embodiments, optical performance of the lens may be improved.

### DESCRIPTION OF DRAWINGS

FIG. 1 is a diagram illustrating a method of manufacturing a plastic lens according to an example embodiment of the present disclosure.

FIG. 2 is a diagram illustrating a process of first heating of a lens preform in a method of manufacturing a plastic lens according to an example embodiment of the present disclosure.

FIG. 3 is a diagram illustrating a process of second heating of a lens preform in a method of manufacturing a plastic lens according to an example embodiment of the present disclosure.

FIG. 4 is a diagram illustrating changes in temperature of a lens form in a method of manufacturing a plastic lens according to an example embodiment of the present disclosure.

FIG. 5 is a diagram illustrating a process of forming a lens by a method of manufacturing a plastic lens according to an example embodiment of the present disclosure.

FIG. 6 is a cross-sectional diagram illustrating a molding apparatus for manufacturing a plastic lens according to an example embodiment of the present disclosure.

FIG. 7 is a perspective diagram illustrating a first molding apparatus of a molding apparatus for manufacturing a plastic lens according to an example embodiment of the present disclosure.

FIG. 8 is a plan diagram illustrating a first molding apparatus of a molding apparatus for manufacturing a plastic lens according to an example embodiment of the present disclosure.

FIG. 9 is a cross-sectional diagram illustrating a heating member of a molding apparatus for manufacturing a plastic lens according to an example embodiment of the present disclosure.

FIG. 10 is a diagram illustrating a dispositional structure of a first heating portion and a flow path portion of a first molding apparatus of a molding apparatus for manufacturing a plastic lens.

FIG. 11 is a diagram illustrating a configuration of a heating portion of a molding apparatus for manufacturing a plastic lens according to an example embodiment of the present disclosure.

FIG. 12 is a diagram illustrating a direction of flow of fluid in a molding apparatus for manufacturing a plastic lens according to an example embodiment of the present disclosure.

FIG. 13 is a perspective diagram illustrating a first molding apparatus of a molding apparatus for manufacturing a plastic lens according to another example embodiment of the present disclosure.

FIG. 14 is a perspective diagram illustrating a first molding apparatus of a molding apparatus for manufacturing a plastic lens according to another example embodiment of the present disclosure.

FIG. 15 is a cross-sectional diagram illustrating an example in which a lens preform is disposed in a cavity of a molding apparatus.

FIG. 16 is a cross-sectional diagram illustrating an example in which a lens preform is formed as a lens.

FIG. 17 is an enlarged diagram illustrating portion “A” illustrated in FIG. 15.

FIG. 18 is a diagram illustrating a modified example of the example illustrated in FIG. 17.

FIG. 19 is a perspective diagram illustrating a lens according to an example embodiment of the present disclosure.

FIG. 20 is a lateral diagram illustrating a lens according to an example embodiment of the present disclosure.

FIG. 21 is a diagram illustrating a modified example of the example illustrated in FIG. 19.

FIG. 22 is a cross-sectional diagram illustrating a lens assembly according to an example embodiment of the present disclosure.

FIG. 23 is a perspective diagram illustrating a lens according to another example embodiment of the present disclosure.

FIG. 24 is a plan diagram illustrating a lens according to another example embodiment of the present disclosure.

FIG. 25A is a cross-sectional diagram taken along line I-I′ in FIG. 23, FIG. 25B is a cross-sectional diagram taken along line II-II′ in FIG. 23, and FIG. 25C is a diagram illustrating a modified example of the example illustrated in FIG. 25B.

FIG. 26 is a cross-sectional diagram illustrating a lens assembly according to another example embodiment of the present disclosure.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### MODE FOR INVENTION

Hereinafter, while example embodiments of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that would be known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Herein, it is noted that use of the term “may” with respect to an example or embodiment, for example, as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. As used herein “portion” of an element may include the whole element or a part of the whole element less than the whole element.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” “lower,” and the like may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure is to provide a plastic lens having improved optical performance, a method for manufacturing a plastic lens and a molding apparatus for manufacturing a plastic lens.

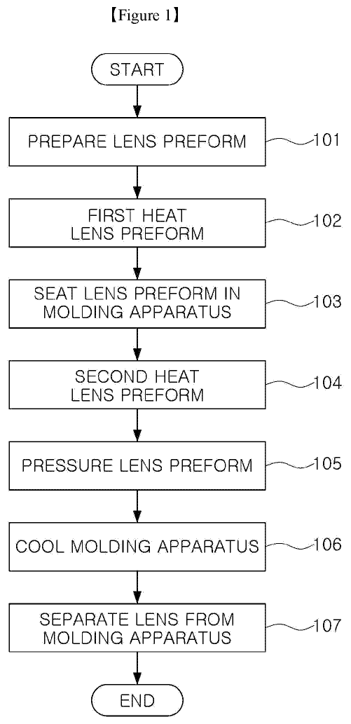

FIG. 1 is a diagram illustrating a method of manufacturing a plastic lens according to an example embodiment. In the example embodiments, processes may be performed sequentially, but an example embodiment thereof is not limited thereto. For example, the order of the processes may be changed, and at least two processes may be performed in parallel.

Referring to FIG. 1, the method for manufacturing a plastic lens in the example embodiment may include a first process.

The first process may be a process 101 of preparing a lens preform 1. The lens preform 1 may be a preform for manufacturing a lens L (See, FIG. 5).

The lens preform 1 may be molded by any molding method such as an injection molding method or a compression molding method. The lens preform 1 may be molded from a thermoplastic resin material.

For example, the lens preform 1 may be molded by an injection molding method. The lens preform 1 may be injection molded by supplying a thermoplastic resin to a molding apparatus for manufacturing the lens preform.

Alternatively, the lens preform 1 may be molded by a compression molding method. For example, the lens preform 1 may be molded by applying heat to a thermoplastic resin material (for example, a material in a pellet state) and pressing the thermoplastic resin material.

Alternatively, the lens preform 1 may be molded by freezing, drying, and pulverizing pellets to form the pellets to be powder, and pressing the powder in a vacuum state.

Alternatively, the lens preform 1 may be formed by laminating a plurality of films or sheets formed of thermoplastic resin material and pressing the films or sheets.

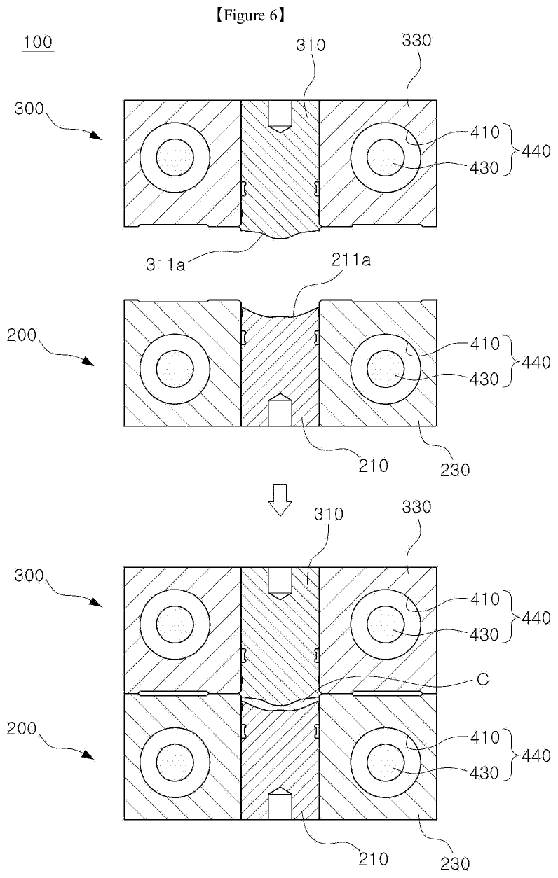

The lens preform 1 may have a volume and a weight the same as those of as the lens L. The lens preform 1 may have a shape similar to that of the lens L, but may be different from a shape of a cavity C of a molding apparatus 7 for manufacturing a lens (See, FIG. 6).

The manufactured lens preform 1 may be separately stored in an environment of which a temperature is lower than a glass transition temperature Tg.

The method of manufacturing a plastic lens according to an example embodiment does not necessarily include the first process. For example, when the lens preform 1 is prepared separately, the method of manufacturing a plastic lens according to an example embodiment may start from a second process as below.

A method of manufacturing a plastic lens according to an example embodiment may include a second process. The second process may be a process 102 of first heating of the lens preform 1.

In the second process, the lens preform 1 may be first heated to a temperature within a first temperature range. The temperature within a first temperature range may be a temperature equal to or lower than the glass transition temperature Tg of the lens preform 1. The temperature within a first temperature range may be higher than the temperature at which the lens preform 1 has been stored.

The temperature within a first temperature range may be from a temperature lower than the glass transition temperature Tg of the lens preform 1 by 50° C. to the glass transition temperature Tg.

For example, the temperature within a first temperature range may be Tg−50° C. to Tg.

In the method of manufacturing a plastic lens according to an example embodiment, the lens preform 1 may be pressed to form the lens L. In this case, it may be necessary to apply heat to the lens preform 1 such that the lens preform 1, in a solid state, may have fluidity. However, when the lens preform 1 is seated in the molding apparatus 7 and is heated, a sufficient period of time may be consumed to heat the lens preform 1 to a temperature required for molding the lens L such that productivity may degrade.

Therefore, the method of manufacturing a plastic lens according to an example embodiment may include a process of preheating the lens preform 1. Accordingly, the time for heating to the temperature required for molding the lens L may be shortened, such that the time for manufacturing the lens may be shortened and productivity may improve.

The lens preform 1 may be heated to a temperature equal to or lower than the glass transition temperature Tg of the lens preform 1 in the primary heating process. When the lens preform 1 is heated to a temperature above the glass transition temperature Tg, the lens preform 1 may have fluidity. When the lens preform 1 is seated on the molding apparatus 7 in this state, it may be difficult to fasten the position of the lens preform 1, which may cause molding defects.

Therefore, in the method of manufacturing a plastic lens according to an example embodiment, the lens preform 1 may be preheated to improve productivity, and the lens preform 1 may be preheated to a temperature equal to or lower than the glass transition temperature Tg to secure reliability of a product.

Meanwhile, in the second process, the lens preform 1 may be moved while first heated, which will be described later with reference to FIG. 3.

The method of manufacturing a plastic lens according to an example embodiment may include a third process. The third process may be a process 103 of mounting the lens preform 1 on the molding apparatus 7.

In the third process, the lens preform 1 may be seated on the molding apparatus 7. The molding apparatus 7 may be first heated to the temperature within a first temperature range. Therefore, even after the lens preform 1 is seated on the molding apparatus 7, the temperature of the lens preform 1 may be maintained.

The molding apparatus 7 may include a first molding apparatus 5 and a second molding apparatus 6, and one of the first molding apparatus 5 and the second molding apparatus 6 may be a movable molding apparatus, and the other may be a fixed molding apparatus. The lens preform 1 may be seated on a molding portion of a movable molding apparatus or a molding portion of a fixed molding apparatus.

A molding portion corresponding to a shape of the lens L may be provided on opposing surfaces of the first molding apparatus 5 and the second molding apparatus 6. For example, a first molding apparatus 5 may include a first molding portion corresponding to the shape of an object-side surface of the lens L, and the second molding apparatus 6 may include a second molding portion corresponding to a shape of an image-side surface of the lens L.

When the first molding apparatus 5 and the second molding apparatus 6 are combined, a cavity C may be formed between the first molding apparatus 5 and the second molding apparatus 6. The cavity C may be a space in which the lens L is molded.

The method of manufacturing a plastic lens according to an example embodiment may include a fourth process. The fourth process may be a process 104 of second heating of the lens preform 1.

In the fourth process, the lens preform 1 may be second heated to a temperature within a second temperature range. For example, by heating the molding apparatus 7 to the temperature within a second temperature range, the lens preform 1 disposed in the cavity C of the molding apparatus 7 may be heated to the temperature within a second temperature range.

The temperature within a second temperature range may be higher than the temperature within a first temperature range.

The temperature within a second temperature range may be equal to or higher than the glass transition temperature Tg of the lens preform 1. For example, the temperature within a second temperature range may be from the glass transition temperature Tg of the lens preform 1 to a temperature higher than the glass transition temperature Tg by 100° C.

The temperature within a second temperature range may thus be Tg to Tg+100° C.

In the method of manufacturing a plastic lens according to an example embodiment, since the first heated lens preform 1 is second heated in the molding apparatus 7, the time for heating to the temperature required for molding the lens L may be shortened. Thus, in the method of manufacturing a plastic lens according to an example embodiment, rapid heating of the lens preform 1 may be available.

Therefore, productivity of the lens L may improve, and a cycle of the lens manufacturing process may be shortened.

Since the lens preform 1 is heated to a temperature equal to or higher than the glass transition temperature Tg, the lens preform 1 in a solid state may have fluidity in the secondary heating process.

However, when the heating is performed to an excessively high temperature, the lens preform 1 may be phase-changed from solid to liquid. When the liquid lens preform 1 is pressed, it may be difficult to implement a desired shape of the lens L. Also, when the lens preform 1 is phase-changed to liquid, air bubbles may be formed in the lens preform 1, and accordingly, bubbles may be present in the manufactured lens L, which may cause defects in product molding.

Therefore, in the method of manufacturing a plastic lens according to an example embodiment, the lens preform 1 may be heated to a temperature equal to or higher than the glass transition temperature Tg in the secondary heating process, and may be heated to not be phase-changed to liquid.

The method of manufacturing a plastic lens according to an example embodiment may include a fifth process. The fifth process may be a process 105 of pressing the lens preform 1.

When the temperature of the lens preform 1 is equal to or higher than the glass transition temperature Tg, the lens preform 1 may be pressed.

The lens preform 1 disposed in the cavity C of the molding apparatus 7 may be pressed by a movable molding apparatus. The movable molding apparatus may move towards the fixed molding apparatus, and may press the lens preform 1 disposed in the cavity C. For example, when the first molding apparatus 5 is a fixed molding apparatus and the second molding apparatus 6 is a movable molding apparatus, the second molding apparatus 6 may move to press the lens preform 1.

Accordingly, the lens preform 1 may be formed to have a shape corresponding to the shape of the cavity C.

The lens preform 1 may be pressed while being heated to a temperature within a second temperature range, a temperature equal to or higher than the glass transition temperature Tg of the lens preform 1.

To shorten the cycle of the lens manufacturing process, the fifth process may be performed simultaneously with the fourth process, but an example embodiment thereof is not limited thereto. For example, the fifth process may be performed after the fourth process.

The method of manufacturing a plastic lens according to an example embodiment may include a sixth process. The sixth process may be a process 106 of cooling the molding apparatus 7.

In the sixth process, the molding apparatus 7 may be cooled to less than a glass transition temperature Tg or to a first temperature range. Accordingly, the lens molded in the cavity C of the molding apparatus 7 may also be cooled. When the cooling is completed, the first molding apparatus 5 and the second molding apparatus 6 may be separated from each other.

The process 106 of cooling the molding apparatus 7 may include supplying a fluid into the molding apparatus 7. The fluid may be air or water.

The method of manufacturing a plastic lens according to an example embodiment may include a seventh process. The seventh process may be a process 107 of separating the lens L from the molding apparatus 7.

In the seventh process, the lens L, which has been molded, may be separated from the molding apparatus 7 and may be stored separately.

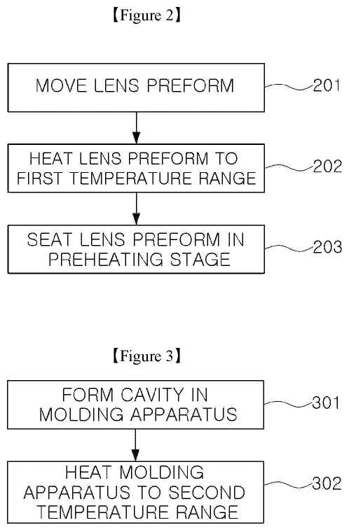

FIG. 2 is a diagram illustrating a process of first heating of a lens preform in a method of manufacturing a plastic lens according to an example embodiment. In the example embodiments, processes may be performed sequentially, but an example embodiment thereof is not limited thereto. For example, the order of the processes may be changed, and at least two processes may be performed in parallel.

Referring to FIG. 2, the process of first heating of the lens preform 1 may include a process 201 of moving the lens preform 1 and a process 202 of heating the lens preform 1 to a first temperature range. The process of first heating of the lens preform 1 may further include a process 203 of seating the lens preform 1 in a preheating stage.

The prepared lens preform 1 may move to the molding apparatus 7 for lens molding. For example, the lens preform 1 may be adsorbed by a moving device 4 and may be moved to the molding apparatus 7.

The lens preform 1 may be heated to the temperature within a first temperature range while moving to the molding apparatus 7.

For example, the moving device 4 may include an adsorption portion 2 and a heating portion 3, and the lens preform 1 may be heated through the heating portion 3 in a state in which the lens preform 1 has been adsorbed through the adsorption portion 2. The adsorption portion 2 may vacuum-adsorb (lift, hold, etc.) the lens preform 1.

When the lens preform 1 is heated after seated in the molding apparatus 7, a substantial period of time may be consumed to heat to a temperature required for molding the lens L, which may degrade productivity.

However, in the manufacturing method of the plastic lens according to an example embodiment, since the lens preform 1 may be preheated while being moved to the molding apparatus 7, the time for heating to a temperature required to mold the lens L may be shortened.

Meanwhile, the lens preform 1 may be seated in the preheating stage provided in the molding apparatus 7 and may be heated such that the temperature of the lens preform 1 reaches the temperature within a first temperature range more swiftly.

FIG. 3 is a diagram illustrating a process of second heating of a lens preform in a method of manufacturing a plastic lens according to an example embodiment. In the example embodiments, processes may be performed sequentially, but an example embodiment thereof is not limited thereto. For example, the order of the processes may be changed, and at least two processes may be performed in parallel.

Referring to FIG. 3, a process of second heating of the lens preform 1 may include a process 301 of forming a cavity C in the molding apparatus 7 and a process 302 of heating the molding apparatus 7 to a temperature within a second temperature range.

The process 301 of forming the cavity C in the molding apparatus 7 may be a process of combining the first molding apparatus 5 with the second molding apparatus 6. The lens preform 1 may be disposed in the cavity C of the molding apparatus 7. The lens preform 1 may be heated by heating the molding apparatus 7.

The lens preform 1 may be indirectly heated by heating the molding apparatus 7. For example, by heating the molding apparatus 7, the temperature of the lens preform 1 may be increased further than the temperature of the first heating.

The process 302 of heating the molding apparatus 7 to the temperature within a second temperature range may include increasing the temperature of the cavity C to be higher than temperatures of the other portions of the molding apparatus 7.

A temperature of the lens preform 1 may increase from a temperature within the first temperature range to the temperature within a second temperature range, and accordingly, the solid lens preform 1 may have fluidity. Accordingly, by pressing the lens preform 1 through the molding apparatus 7, a shape of the lens preform 1 may be transformed to a shape of the lens L, a final product. For example, the lens preform 1 may be plastically deformed to form the lens L.

The molding apparatus 7 may include a temperature sensor, and the temperature of the molding apparatus 7 (or the temperature of the lens preform 1) may be measured through the temperature sensor.

A heating portion for generating heat may be disposed in the molding apparatus 7, and the molding apparatus 7 may be heated through the heating portion. For example, the heating portion may include a first heating portion for heating the molding apparatus 7 to a temperature within the first temperature range and a second heating portion for heating the molding apparatus 7 to the temperature within a second temperature range.

The heating temperature of the second heating portion may be higher than the heating temperature of the first heating portion.

The second heating portion may heat a pin core of the first molding apparatus 5 and a pin core of the second molding apparatus 6, forming the cavity C.

The second heating portion may include a heating wire disposed in the first molding apparatus 5 and the second molding apparatus 6, and may heat the molding apparatus 7 by applying power to the heating wires.

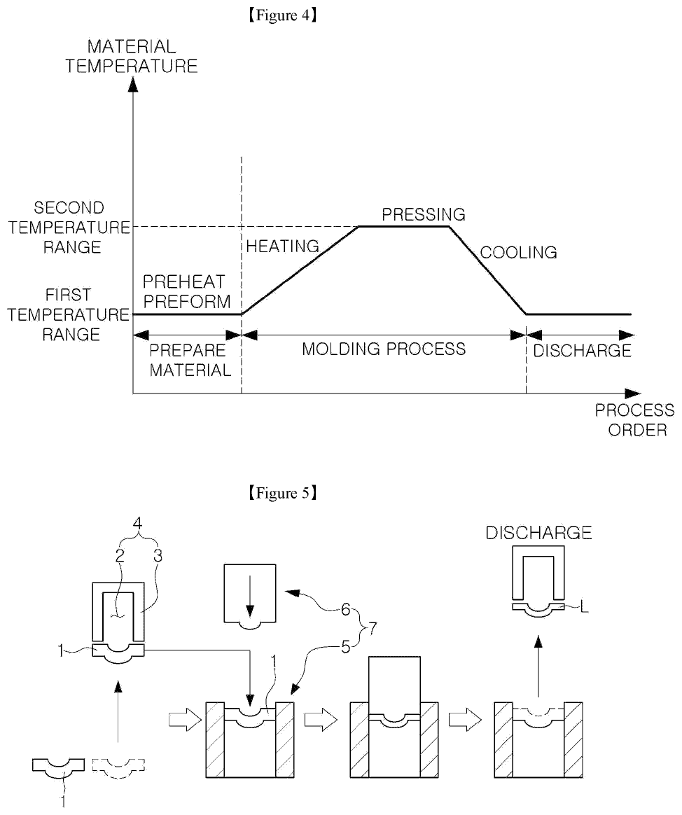

FIG. 4 is a diagram illustrating changes in temperature of a lens form in a method of manufacturing a plastic lens according to an example embodiment. FIG. 5 is a diagram illustrating a process of forming a lens by a method of manufacturing a plastic lens according to an example embodiment.

The lens preform 1 may be formed to mold the lens L. The prepared lens preform 1 may move to the molding apparatus 7 and may be first heated while being moved.

For example, the lens preform 1 may be adsorbed by the moving device 4 and may move to the molding apparatus, and may be heated to a temperature within the first temperature range while being moved to the molding apparatus 7.

The moving device 4 may include an adsorption portion 2 and a heating portion 3, and the lens preform 1 may be heated through the heating portion 3 in a state in which the lens preform 1 is adsorbed through the adsorption portion 2. The adsorption portion 2 may vacuum adsorb the lens preform 1.

Since the lens preform 1 is preheated, the time to reach the temperature for molding the lens L may be shortened.

Similarly to the lens preform 1, the molding apparatus 7 may be first heated to a temperature within the first temperature range. Therefore, even after the lens preform 1 is seated on the molding apparatus 7, the temperature of the lens preform 1 may be maintained.

The lens preform 1 disposed in the cavity C of the molding apparatus 7 may be second heated to the temperature within a second temperature range. The lens preform 1 may be pressed in the cavity C of the molding apparatus 7, thereby forming the lens L, a final product.

The lens preform 1 may have a volume and a weight the same as those of the lens L.

In the method of manufacturing a plastic lens according to an example embodiment, since the lens preform 1 is pressed to form the lens L, deterioration of optical performance occurring in a general injection molded lens (flow mark, weld line, birefringence, or the like) may be prevented. Accordingly, optical performance of the lens L may be improved.

When the lens preform 1 is manufactured by injection molding, the lens preform 1 may have issues such as a flow mark, a weld line, and birefringence. However, since the lens preform 1 is pressed in a heated state to have fluidity, the issues of the injection-molded lens preform 1 may be addressed in the lens L, a final product. Accordingly, the method of manufacturing a plastic lens according to an example embodiment may improve the optical performance of the lens L.

FIG. 6 is a cross-sectional diagram illustrating a molding apparatus for manufacturing a plastic lens according to an example embodiment.

Referring to FIG. 6, the molding apparatus 100 for manufacturing a plastic lens according to an example embodiment may include a first molding apparatus 200 and a second molding apparatus 300. One of the first molding apparatus 200 and the second molding apparatus 300 may be a movable molding apparatus, and the other may be a fixed molding apparatus.

The first molding apparatus 200 and the second molding apparatus 300 may be coupled to each other and may be separated from each other. For example, when the first molding apparatus 200 is a fixed molding apparatus and the second molding apparatus 300 is a movable molding apparatus, the second molding apparatus 300 may move and may be combined with or separated from the first molding apparatus 200.

A cavity C in which a lens L is formed may be provided between the first molding apparatus 200 and the second molding apparatus 300.

A molding portion corresponding to a shape of the lens L may be provided on surfaces of the first molding apparatus 200 and the second molding apparatus 300 opposing each other.

The first molding apparatus 200 may include a first core portion 210 and a first body portion 230. The first body portion 230 may include an accommodation space in which the first core portion 210 is accommodated, and the accommodation space may have a hole shape or a groove shape.

The second molding apparatus 300 may include a second core portion 310 and a second body portion 330. The second body portion 330 may include an accommodation space in which the second core portion 310 is accommodated, and the accommodation space may have a hole shape or a groove shape.

The first body portion 230 of the first molding apparatus 200 and the second body portion 330 of the second molding apparatus 300 may oppose each other. Fastening portions may be provided on surfaces on which the first body portion 230 of the first molding apparatus 200 and the second body portion 330 of the second molding apparatus 300 oppose each other. One of the fastening portions disposed to oppose each other may have a groove shape or a hole shape, and the other may have a protrusion shape.

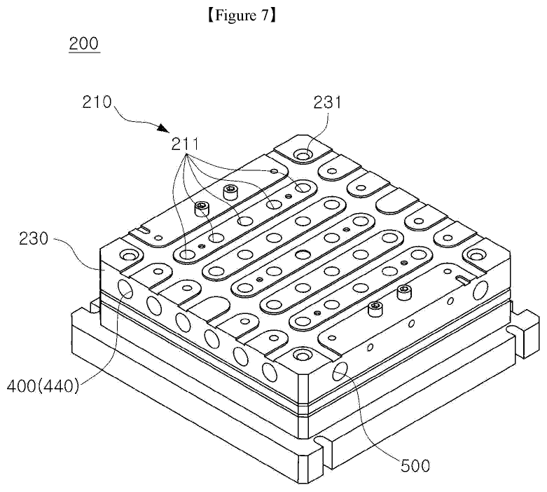

For example, a fastening groove 231 may be provided on one surface of the first body portion 230 of the first molding apparatus 200 (see FIG. 7). In this case, a fastening protrusion may be provided on one surface of the second body portion 330 of the second molding apparatus 300. The fastening portion may have a function to guide the coupling of the first molding apparatus 200 with the second molding apparatus 300. Accordingly, the first molding apparatus 200 and the second molding apparatus 300 may be coupled to each other such that the core portions thereof may oppose each other.

The first core portion 210 may be accommodated in the first body portion 230. The first core portion 210 may include at least one pin core, and a molding portion corresponding to a shape of the manufactured lens L may be provided on one surface of the pin core.

For example, a first molding portion 211a may be provided on one surface of the pin core of the first core portion 210. The first molding portion 211a may have a shape corresponding to an exterior shape of an object-side surface of the lens L.

The second core portion 310 may be accommodated in the second body portion 330. The second core portion 310 may include at least one pin core, and a molding portion corresponding to the shape of the manufactured lens L may be provided on one surface of the pin core.

For example, a second molding portion 311a may be provided on one surface of the pin core of the second core portion 310, and the second molding portion 311a may have a shape corresponding to the exterior shape of an image-side surface of the lens.

A cavity C may be formed between the first core portion 210 of the first molding apparatus 200 and the second core portion 310 of the second molding apparatus 300.

Since the configurations of the first molding apparatus 200 and the second molding apparatus 300 are similar, the overlapping description of the second molding apparatus 300 will not be further provided, and the first molding apparatus 200 will be further described below.

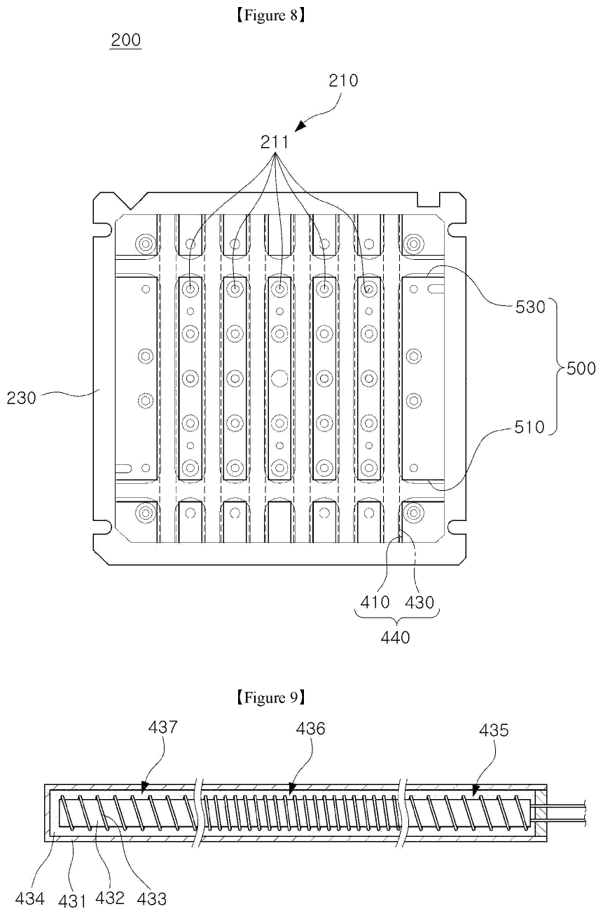

FIG. 7 is a perspective diagram illustrating a first molding apparatus of a molding apparatus for manufacturing a plastic lens according to an example embodiment. FIG. 8 is a plan diagram illustrating a first molding apparatus of a molding apparatus for manufacturing a plastic lens according to an example embodiment.

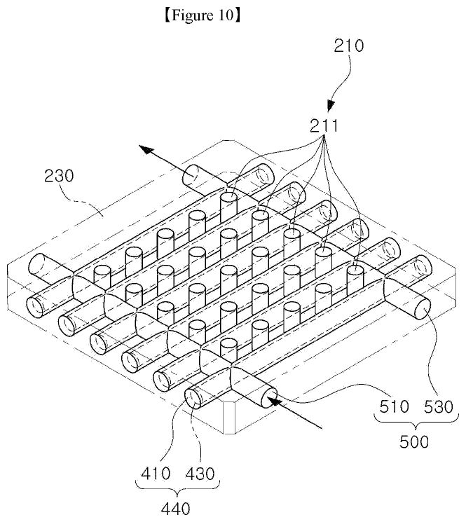

FIG. 9 is a cross-sectional diagram illustrating a heating member of a molding apparatus for manufacturing a plastic lens according to an example embodiment. FIG. 10 is a diagram illustrating a dispositional structure of a first heating portion and a flow path portion of a first molding apparatus of a molding apparatus for manufacturing a plastic lens.

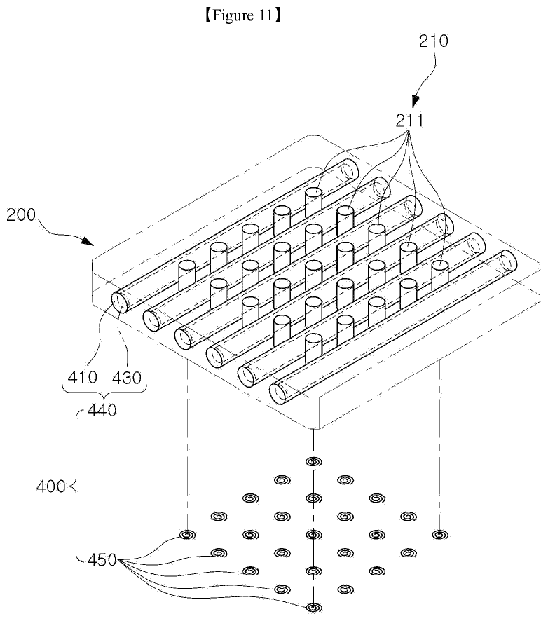

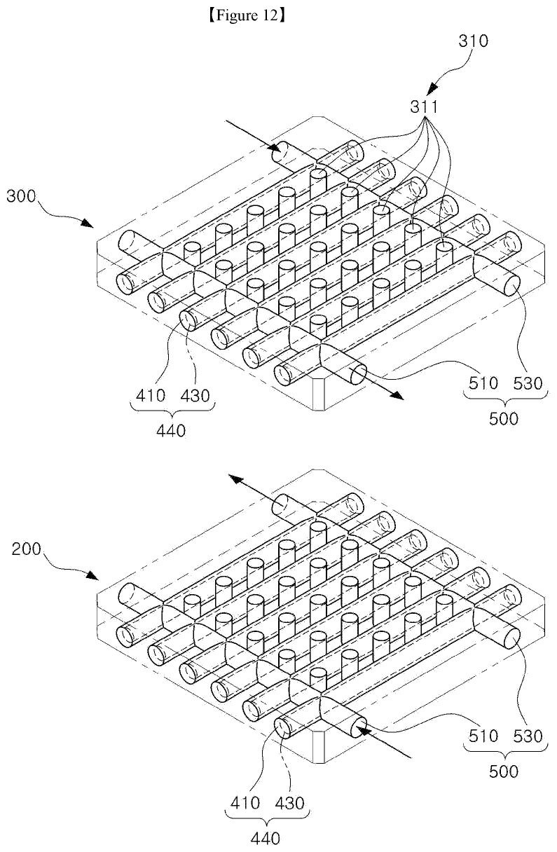

FIG. 11 is a diagram illustrating a configuration of a heating portion of a molding apparatus for manufacturing a plastic lens according to an example embodiment. FIG. 12 is a diagram illustrating a direction of flow of fluid in a molding apparatus for manufacturing a plastic lens according to an example embodiment.

Referring to FIG. 7, the first core portion 210 may be accommodated in the first body portion 230. The first core portion 210 may include one or more pin core 211. When the first core portion 210 includes a plurality of pin cores 211, a molding portion corresponding to the shape of the lens L to be manufactured may be provided on one surface of each pin core 211.

Accordingly, a molding apparatus 100 for manufacturing a plastic lens according to an example embodiment may manufacture several lenses L in a single process.

In the example embodiment illustrated in FIG. 7, the first core portion 210 may include 25 pin cores 211, and the 25 pin cores 211 may be arranged in five rows and five columns. However, the number and arrangement form of the plurality of pin cores 211 are not limited thereto, and may be varied.

A heating portion 400 for generating heat may be disposed in the first body portion 230. The heating portion 400 may include a first heating portion 440 for heating the first body portion 230. Also, the heating portion 400 may include a second heating portion 450 for heating the first core portion 210 (see FIG. 11). Unless otherwise indicated, the heating portion 400 may also be disposed in the second body portion 330.

The first body portion 230 may be heated by the first heating portion 440, and accordingly, the first core portion 210 accommodated in the first body portion 230 may also be heated. Thus, the first heating portion 440 may indirectly heat the first core portion 210 through the first body portion 230.

When the first molding apparatus 200 and the second molding apparatus 300 are not combined, the first heating portion 440 may heat the first body portion 230 and the second body portion 330 to a first temperature range. When the first molding apparatus 200 and the second molding apparatus 300 are combined and the lens preform 1 is disposed in the cavity C, the second heating portion 450 may heat the first core portion 210 and the second core portion 310 to the temperature within a second temperature range.

The heating temperature of the second heating portion 450 may be higher than the heating temperature of the first heating portion 440.

The heating temperature of the first heating portion 440 may be equal to or less than the glass transition temperature Tg of the lens preform 1. For example, the heating temperature of the first heating portion 440 may be from a temperature lower than the glass transition temperature Tg of the lens preform 1 by 50° C. to the glass transition temperature Tg.

The heating temperature of the second heating portion 450 may be equal to or greater than the glass transition temperature Tg of the lens preform 1. For example, the heating temperature of the second heating portion 450 may be from the glass transition temperature Tg of the lens preform 1 to a temperature higher than the glass transition temperature Tg by 100° C.

A temperature sensor may be disposed in the first body portion 230. Accordingly, the temperature of the first body portion 230 (or the temperature of the lens preform 1) may be measured through the temperature sensor.

Referring to FIG. 8, the first heating portion 440 may include an accommodating portion 410 penetrating one side of the first body portion 230 and a heating member 430 disposed in the accommodating portion 410. A plurality of the accommodating portion 410 and a plurality of the heating member 430 may be disposed.

When the plurality of heating members 430 are disposed, each heating member 430 may be disposed between the pin cores 211. For example, when the plurality of pin cores 211 are arranged in five rows and five columns, two heating members disposed on an outermost side of the plurality of heating members 430 may be disposed on one side of a pin core in the first row and a pin core in the fifth row, respectively. The other heating members may be disposed between the pin cores in each row.

Referring to FIG. 9, the heating member 430 may include a conductive housing 431, an insulating core 432, and a wound coil 433. The conductive housing 431 may have an internal space, and may be, for example, a metal.

The insulating core 432 may be disposed in the conductive housing 431, and the wound coil 433 may be disposed on an external surface of the insulating core 432. An insulating material 434 may fill a region between the conductive housing 431 and the insulating core 432.

Heat may be generated by the heating member 430 by applying power to the wound coil 433. The heating member 430 may be, for example, a cartridge heater.

When the first core portion 210 includes a plurality of pin cores 211, the temperature of the plurality of pin cores 211 may not be uniformly increased. Accordingly, the molding apparatus 100 for manufacturing a plastic lens according to an example embodiment may increase the temperatures differently in different portions of the heating member 430.

For example, the heating member 430 may be divided into a plurality of portions according to the amount of heat generated. For example, the heating member 430 may be divided into a first portion 435, a second portion 436, and a third portion 437 in a length direction.

The first portion 435 and the third portion 437 may refer to both ends of the heating member 430, and the second portion 436 may refer to a portion between the first portion 435 and the third portion 437. The second portion 436 may be a central portion of the heating member 430.

The winding spacing of the wound coil 433 disposed on the heating member 430 may be different for each portion of the heating member 430. For example, the winding spacing of the wound coil 433 disposed in the second portion 436 may be narrower than a winding spacing of the wound coil 433 disposed in the first portion 435 and a winding spacing of the wound coil 433 disposed in the third portion 437.

The winding spacing of the wound coil 433 disposed in the first portion 435 and the winding spacing of the wound coil 433 disposed in the third portion 437 may be the same or different.

Accordingly, since the heating member 430 may increase the temperatures differently in different portions of the heating member 430, the temperatures of the plurality of pin cores 211 may be uniformly increased.

Also, when a plurality of heating members 430 are disposed, the amount of heat generated by each heating member 430 may be controlled by varying the winding spacings of the wound coils 433 disposed in the heating members 430 or by varying the amount of current.

Referring to FIG. 10, a flow path portion 500 through which a fluid may be provided may be disposed in the first body portion 230. Unless otherwise indicated, the flow path portion 500 may also be disposed in the second body portion 330.

Fluid may be supplied to the flow path portion 500. During the heating, the fluid supplied to the flow path portion 500 may heat the first body portion 230. During the cooling, the fluid supplied to the flow path portion 500 may cool the first body portion 230.

The fluid may be water or air, but an example embodiment thereof is not limited thereto, and various types of fluids which may heat or cool may be used.

Referring to FIG. 10, the flow path portion 500 may be arranged to be connected to the accommodating portion 410. For example, the accommodating portion 410 may be disposed to have a length along one direction, and the flow path portion 500 may be disposed to have a length along an other direction intersecting the accommodating portion 410.

The flow path portion 500 may include a first flow path 510 connected to one side of the accommodation portion 410 and a second flow path 530 connected to an other side of the accommodation portion 410. The first flow path 510 and the second flow path 530 may be connected to each other by the accommodating portion 410.

The first flow path 510 and the second flow path 530 may be disposed to perpendicularly intersect the accommodating portion 410.

Accordingly, the fluid supplied to the flow path portion 500 may surround the heating member 430 disposed in the accommodating portion 410.

The first flow path 510 may have one side to be opened and closed, and the other side to be closed. The second flow path 530 may have one side to be closed and the other side to be opened and closed. An opening/closing valve may be disposed on the one side of the first flow path 510 and the other side of the second flow path 530.

One of the one side of the first flow path 510 and the other side of the second flow path 530 may be an inlet through which a fluid flows in, and the other may be an outlet through which the fluid is discharged.

For example, the one side of the first flow path 510 may be an inlet through which a fluid flows in, and the other side of the second flow path 530 may be an outlet through which the fluid is discharged.

In a state in which the one side of the first flow path 510 is open and the other side of the second flow path 530 is closed, a fluid may flow in through the one side of the first flow path 510. When the flow path portion 500 and the accommodating portion 410 are filled with a fluid, the one side of the first flow path 510 may be closed.

When power is applied to the heating member 430, heat may be generated by the heating member 430, and accordingly, heat may be transferred to the fluid surrounding the heating member 430. Accordingly, the first body portion 230 may be heated by the first heating portion 440 and the flow path portion 500. Therefore, the time for heating to the temperature required for molding the lens L may be shortened.

When the fluid is water, rapid heating may be available using a phase transition of water.

When the first molding apparatus 200 and the second molding apparatus 300 are separated from each other, the first molding apparatus 200 and the second molding apparatus 300 may be heated to a temperature within a first temperature range by the first heating portion 440.

Referring to FIG. 11, a second heating portion 450 may be disposed in the first molding apparatus 200 and the second molding apparatus 300. The second heating portion 450 may be configured to heat the first core portion 210 of the first molding apparatus 200 and the second core portion 310 of the second molding apparatus 300.

When the first molding apparatus 200 and the second molding apparatus 300 are combined with each other and the lens preform 1 is disposed in the cavity C, the first molding apparatus 200 and the second molding apparatus 300 may be heated to the temperature within a second temperature range by the second heating portion 450. In other words, since the temperature of the lens preform 1 disposed in the cavity C may be increased from a temperature within the first temperature range, the time for the temperature of the lens preform 1 to reach the temperature within a second temperature range may be shortened. Also, the second heating portion 450 may locally heat one portion of the molding apparatus 100, thereby shortening the heating time.

Therefore, the time for heating to the temperature required for molding the lens L may be shortened.

The second heating portion 450 may be disposed in a position in which the second heating portion 450 may heat the first core portion 210 and the second core portion 310. The second heating portion 450 may be disposed around the first core portion 210 and around the second core portion 310.

For example, the second heating portion 450 may be disposed in a lower portion of the pin cores 211 of the first core portion 210 and in an upper portion of the pin cores 311 of the second core portion 310. Here, the lower portion of the pin core 211 of the first core portion 210 may refer to an opposite side of the first molding portion 211a, and the upper portion of the pin core 311 of the second core portion 310 may refer to an opposite side of the second molding portion 311a.

The second heating portion 450 may include a heating wire. The pin core 211 of the first molding apparatus 200 and the pin core 311 of the second molding apparatus 300 may be rapidly heated by applying power to the heating wire.

When each of the first core portion 210 and the second core portion 310 includes a plurality of pin cores, the heating wire may include a plurality of heating wires corresponding to the pin cores, respectively.

The temperature of each pin core may be controlled individually by controlling each of the currents supplied to the plurality of heating wires. Also, each pin core may be grouped with other pin cores and the temperature of the pin core of each group may be controlled by grouping the plurality of heating wires, correspondingly, and controlling the currents supplied to each group of heating wires.

While the first molding apparatus 200 and the second molding apparatus 300 are heated to a temperature within a second temperature range, the movable molding apparatus (e.g., the second molding apparatus 300) may move to the fixed molding apparatus (e.g., the first molding apparatus 200) and may press the lens preform 1, thereby molding the lens L, a final product.

After the molding of the lens L is completed, the first molding apparatus 200 and the second molding apparatus 300 may be cooled by cutting off power supplied to the heating portion 400.

Here, to improve the cooling effect, the one side of the first flow path 510 and the other side of the second flow path 530 may be open.

A relatively cold fluid may be flowed into one side of the first flow path 510, and the heated fluid in the accommodating portion 410 and the flow path portion 500 may be discharged through the other side of the second flow path 530.

Accordingly, the temperature of the first molding apparatus 200 and the second molding apparatus 300 may be swiftly decreased to a temperature less than the glass transition temperature Tg.

Referring to FIG. 12, a direction in which a fluid flows in the first molding apparatus 200 and a direction in which the fluid flows in the second molding apparatus 300 may be opposite to each other.

One of the one side of the first flow path 510 and the other side of the second flow path 530 may be an inlet through which a fluid flows into, and the other may be an outlet through which the fluid is discharged.

For example, in the first molding apparatus 200, the fluid may flow in through the one side of the first flow path 510 and may be discharged to the other side of the second flow path 530, and in the second molding apparatus 300, the fluid may flow in through the other side of the second flow path 530 and may be discharged to the one side of the first flow path 510.

By configuring the direction of flow of the fluid of the first molding apparatus 200 to be opposite to the direction of flow of the fluid of the second molding apparatus 300, the lens L disposed in the plurality of cavities C may be uniformly cooled.

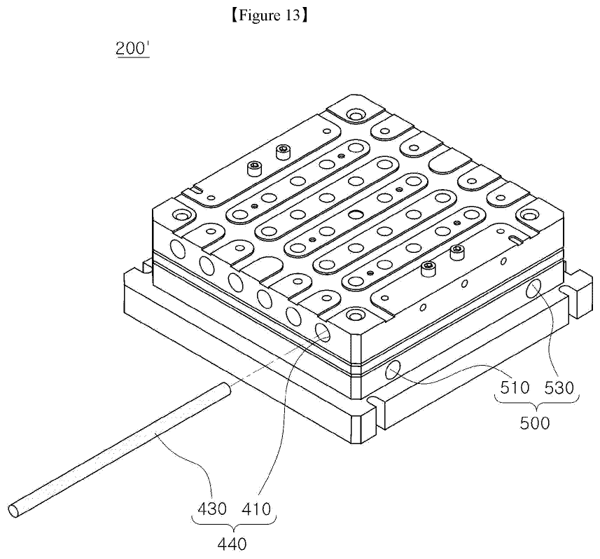

FIG. 13 is a perspective diagram illustrating a first molding apparatus of a molding apparatus for manufacturing a plastic lens according to another example embodiment.

Referring to FIG. 13, a molding apparatus for manufacturing a plastic lens according to another example embodiment may be different from the molding apparatus for manufacturing a plastic lens described in the aforementioned example embodiment in terms of the dispositional forms of the first heating portion 440 and the flow path portion 500. As the configuration of the second heating portion 450 is the same as that of the molding apparatus for manufacturing a plastic lens described in the aforementioned example embodiment, description thereof will not be repeated.

The first molding apparatus 200′ may include a first heating portion 440, a second heating portion 450, and a flow path portion 500. The first heating portion 440 and the flow path portion 500 may not intersect each other. For example, the first heating portion 440 and the flow path portion 500 may be disposed in different positions with reference to a height direction of the first molding apparatus 200′.

Accordingly, the first molding apparatus 200′ may be heated to a temperature within a first temperature range by the first heating portion 440 and may be heated to a temperature within a second temperature range by the second heating portion 450. When the molding of the lens L is completed, power supplied to the first heating portion 440 and the second heating portion 450 may be cut off, and a relatively cool fluid may be supplied to the flow path portion 500 to cool the first molding apparatus 200′.

Although the first molding apparatus 200′ has been described, the dispositional form of the first heating portion 440 and the flow path portion 500 of the second molding apparatus may also be the same as in the first molding apparatus 200′.

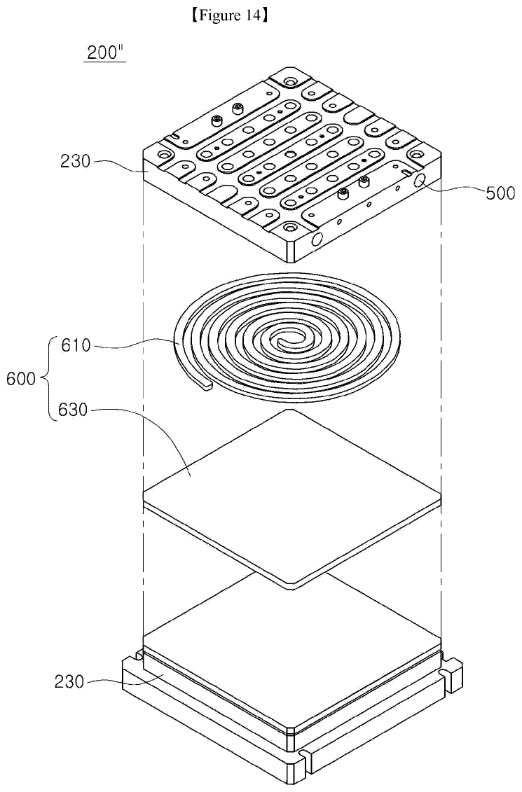

FIG. 14 is a perspective diagram illustrating a first molding apparatus of a molding apparatus for manufacturing a plastic lens according to another example embodiment.

Referring to FIG. 14, a molding apparatus for manufacturing a plastic lens according to another example embodiment may be different from the molding apparatus for manufacturing a plastic lens described in the aforementioned example embodiment in terms of the configuration of the heating portion 600.

The first molding apparatus 200″ may include a first heating portion 600. The first heating portion 600 may include a coil portion 610 and a plate 630 spaced apart from the coil portion 610. The first heating portion 600 may be disposed in the first body portion 230.

The coil portion 610 may include a coil wound in a spiral shape, and the plate 630 may be formed of a conductive material, such as a metal. A high frequency current may be applied to the coil portion 610.

When power is applied to the coil portion 610, the first heating portion 600 may generate heat due to an interaction between the coil portion 610 and the plate 630.

Therefore, the first molding apparatus 200″ may be heated to a temperature within a first temperature range by the first heating portion 600 and may be heated to a temperature within a second temperature range by the second heating portion 450. When the molding of the lens L is completed, power supplied to the first heating portion 600 and the second heating portion 450 may be cut off, and a relatively cool fluid may be supplied to the flow path portion 500 to cool the first molding apparatus 200′.

Although the first molding apparatus 200″ has been described, the configuration of the heating portion 600 of the second molding apparatus may also be the same as in the first molding apparatus 200″.

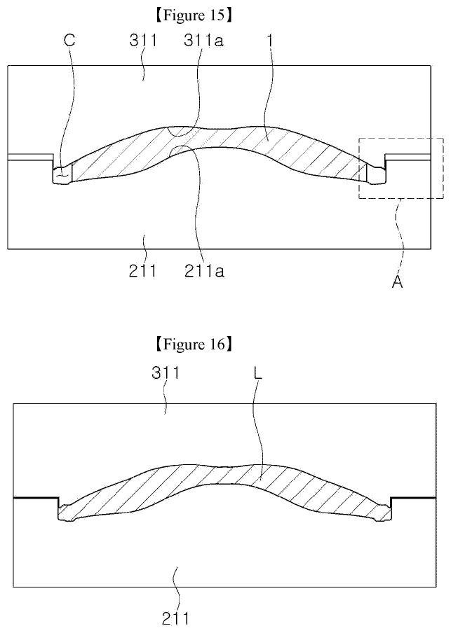

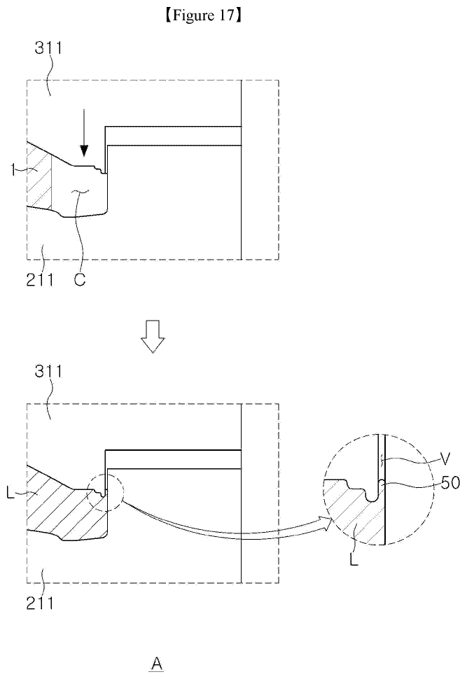

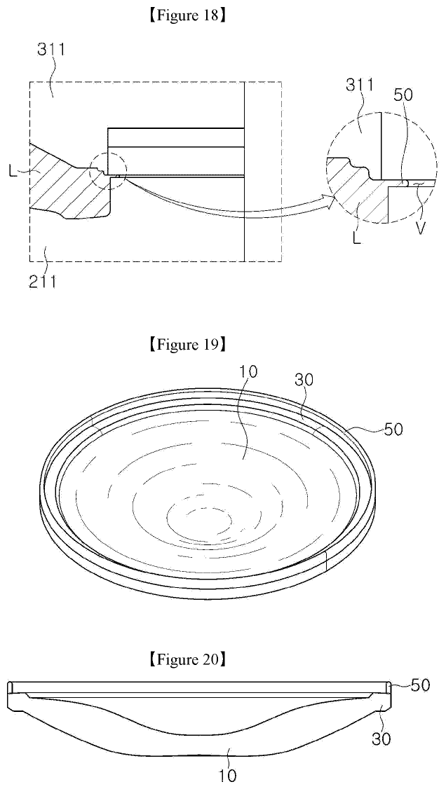

FIG. 15 is a cross-sectional diagram illustrating an example in which a lens preform is disposed in a cavity of a molding apparatus. FIG. 16 is a cross-sectional diagram illustrating an example in which a lens preform is formed as a lens. FIG. 17 is an enlarged diagram illustrating portion “A” illustrated in FIG. 15. FIG. 18 is a diagram illustrating a modified example of the example illustrated in FIG. 17.

Referring to FIG. 15, a cavity C may be formed between a pin core 211 of the first molding apparatus 200 and a pin core 311 of the second molding apparatus 300, and a lens preform 1 may be disposed in the cavity C.

Referring to FIG. 16, the lens preform 1 may be pressed while being indirectly heated through the molding apparatus 100, thereby forming the lens L.

The lens preform 1 may have a volume and a weight the same as those of the lens L, a final product, and a shape of the lens preform 1 may be changed by pressing while heating the lens preform 1 to a temperature within a second temperature range, thereby forming the lens L, a final product.

Since the shape of the lens preform 1 is changed while molding the lens L, it may be necessary to discharge air in the cavity C.

Therefore, in the molding apparatus 100 for manufacturing a lens according to an example embodiment, one of a diameter of the molding portion of the pin core of the movable molding apparatus and a diameter of the molding portion of the pin core of the fixed molding apparatus may be configured to be smaller than the other. For example, the diameter of the first molding portion 211a of the pin core 211 of the first molding apparatus 200 may be larger than the diameter of the second molding portion 311a of the pin core 311 of the second molding apparatus 300.

As illustrated in FIG. 17, the diameter of the first molding portion 211a of the pin core 211 of the fixed molding apparatus (e.g., the first molding apparatus 200) may be greater than the diameter of the second molding portion 311a of the pin core 311 of the movable molding apparatus (e.g., the second molding apparatus 300).

Accordingly, a discharge space V may be formed in an optical axis direction of the lens L, between the pin core of the fixed molding apparatus and the pin core of the movable molding apparatus, and air in the cavity C may be discharged through the discharge space V.

In the molding apparatus 100 for manufacturing a lens according to an example embodiment, to ensure manufacturing reliability of the lens L to be molded, a volume of the lens preform 1 may be configured to be greater than a volume of the cavity C.

Accordingly, as the shape of the lens preform 1 is changed by pressing, a portion of the lens preform 1 may protrude to the discharge space V between the pin core of the fixed molding apparatus and the pin core of the movable molding apparatus. Accordingly, a protrusion 50 may be formed on an edge of the lens L that has been molded. For example, the protrusion 50 may protrude from the edge of the lens L in the optical axis direction.

Accordingly, the lens preform 1 may be changed to have a shape corresponding to the shape of the cavity C, thereby improving the manufacturing reliability of the lens L.

Referring to FIG. 18, in another example embodiment, the diameter of the molding portion of the pin core of the movable molding apparatus may be configured to be the same as the diameter of the molding portion of the pin core of the fixed molding apparatus. For example, the diameter of the first molding portion 211a of the pin core 211 of the fixed molding apparatus (e.g., the first molding apparatus 200) may be the same as the diameter of the second molding portion 311a of the pin core 311 of the movable molding apparatus (e.g., the second molding apparatus 300).

In this case, the discharge space V may be formed in the body portion of the movable molding apparatus or the body portion of the fixed molding apparatus which form a side wall of the cavity C. Air in the cavity C may be discharged through the discharge space V.

In this case, the protrusion 50 may be disposed on the side surface of the lens L. For example, the protrusion 50 may protrude from the side surface of the lens L in a direction perpendicular to the optical axis.

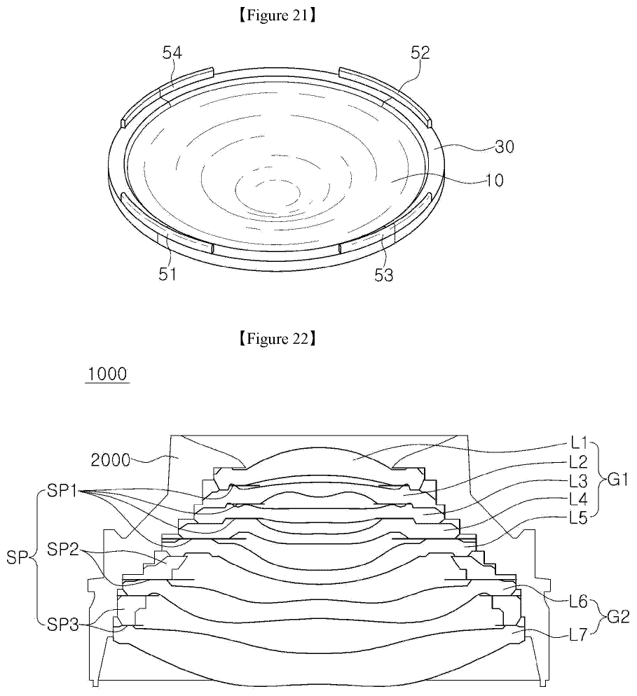

FIG. 19 is a perspective diagram illustrating a lens according to an example embodiment. FIG. 20 is a lateral diagram illustrating a lens according to an example embodiment. FIG. 21 is a diagram illustrating a modified example of the example illustrated in FIG. 19.

The lens L according to an example embodiment may be formed of a plastic material, and may be manufactured through a pressing method rather than a general injection molding method.

Generally, since a lens manufactured by injection molding may have residual stress in a gate portion, a passage of a molten resin, optical performance may be deteriorated. Also, since the gate should be removed from the injection-molded lens, manufacturing processes may be increased, and the lens may be damaged while the gate is removed.

Also, since the lens has a curved shape rather than a planar shape, there may have a variation in thickness for different portions of the cavity of the injection molding apparatus. Accordingly, there may be a difference in speed at which the molten resin flows, and accordingly, flow marks or weld lines may be formed in the injection-molded lens, which may deteriorate optical performance.

However, since the lens L according to an example embodiment may be formed by pressing the lens preform 1, the issues occurring during injection molding may be addressed.

For example, the lens L according to an example embodiment may prevent flow marks and weld lines from being formed, and may prevent deterioration of optical performance caused by residual stress.

Referring to FIGS. 19 and 20, the lens L according to an example embodiment may include an optical portion 10 and a flange portion 30. The optical portion 10 may exhibit optical performance of the lens L. For example, light reflected from a subject may pass through the optical portion 10 and may be refracted.

The lens L according to an example embodiment may have a diameter of 10 mm or greater. The diameter may be a total diameter of the lens L including the optical portion 10 and the flange portion 30.

The optical portion 10 may have refractive power and may have an aspherical shape.

Also, the optical portion 10 may include an object side surface (a surface directed to an object side) and an image side surface (a surface directed to an image side).

The lens L may have different thicknesses for different portions of the lens L. For example, the optical portion 10 may have different curvatures for an object-side surface and an image-side surface. The thickness may refer to a thickness in the optical axis direction.

In the lens L according to an example embodiment, a ratio between the thickest portion and the thinnest portion of the optical portion 10 may be 3.0 or more. For example, T_max/T_min>3.0 may be satisfied, where T_max refers to the greatest thickness of the optical portion 10, and T_min refers to the lowest thickness of the optical portion 10.

The flange portion 30 may fasten the lens L to another element, a lens barrel or another lens, for example.

The flange portion 30 may extend from a circumference of the optical portion 10 and may be integrated with the optical portion 10.

The flange portion 30 may include a protrusion 50 protruding from one surface of the flange portion 30. One surface of the flange portion 30 may be an object-side surface or an image-side surface of the flange portion 30.

For example, the protrusion 50 may be disposed on an edge of one surface of the flange portion 30. The protrusion 50 may extend in the optical axis direction.

The protrusion 50 may be continuously disposed along the circumferential direction on the edge of one surface of the flange portion 30. Accordingly, a length of the circumference of the flange portion 30 may be the same as the length of the circumference of the protrusion portion 50.

The protrusion 50 and the flange 30 may have a surface disposed on the same plane. For example, the side surface of the protrusion portion 50 and the side surface of the flange portion 30 may be disposed on the same plane. Accordingly, the side surface of the protrusion 50 and the side surface of the flange 30 may be continuously disposed.

The protrusion 50 may have a length in the optical axis direction and a width in a direction perpendicular to the optical axis.

The length of the protrusion 50 may be 100 μm (microns) or less, and a width of the protrusion 50 may be 80 μm or less. The length and width may be configured as above to prevent the protrusion 50 from interfering with the other components when the lens L is assembled to the lens barrel.

A center of the object-side surface of the lens L may exactly match a center of the image-side surface, but it may be difficult for the centers to be physically exactly matched in the manufacturing process. Accordingly, the center of the object-side surface of the lens L and the center of the image-side surface may be slightly shifted within an allowable error range. The allowable error range may be predetermined in the manufacturing stage according to the design of the lens L.

The above example may indicate that, in the process of molding the lens L, the center of the pin core 211 of the first molding apparatus 200 may not match the center of the pin core 311 of the second molding apparatus 300 within an allowable error range.

In this case, as a width of the discharge space V between the pin core 211 of the first molding apparatus 200 and the pin core 311 of the second molding apparatus 300 changes along the circumference of the cavity C, the width of the protrusion 50 of the lens L may also change along the circumference of the lens L.

For example, the width of the protrusion 50 may increase and then decrease along the circumferential direction.

Referring to FIG. 21, the protrusion 50 may include a plurality of protrusions spaced apart from each other. As an example, a plurality of protrusions may include a first protrusion 51 and a second protrusion 52 disposed to oppose each other with reference to the optical axis, and a third protrusion 53 and a fourth protrusion 54 disposed to oppose each other with reference to the optical axis.

The number of protrusions is not limited to the illustrated example.

A sum of the lengths of the circumferences of the plurality of protrusions in the circumferential direction may be 80% or more of the circumference of the flange portion 30.

Each of the widths of the plurality of protrusions may decrease or increase along the circumference of the lens L.

In another example embodiment, the protrusion 50 may extend in a direction perpendicular to the optical axis from one surface of the flange 30 (see FIG. 18). One surface of the flange portion 30 may be a side surface of the flange portion 30. The configuration of the protrusion 50 may be the same as the configuration of the protrusion 50 described above, other than a direction in which the protrusion 50 protrudes.

FIG. 22 is a cross-sectional diagram illustrating a lens assembly according to an example embodiment.

Referring to FIG. 22, a lens assembly 1000 according to an example embodiment may include a first lens group G1 and a second lens group G2, and a lens barrel 2000 accommodating the first lens group G1 and the second lens group G2.

The first lens group G1 and the second lens group G2 may be arranged in order from an object side along the optical axis. For example, the first lens group G1 may be disposed more adjacent to the object side than the second lens group G2.

Each of the first lens group G1 and the second lens group G2 may include at least one lens disposed along an optical axis. When one or more of the first and second lens groups G1 and G2 includes a plurality of lenses, the plurality of lenses may be spaced apart from each other by a predetermined distance along the optical axis. The optical portions of the lenses may be spaced apart from each other, and the flange portions of the lenses may be in contact with each other.

The first lens group G1 may include a first lens L1, a second lens L2, a third lens L3, a fourth lens L4, and a fifth lens L5, and the second lens group G2 may include a sixth lens L6 and a seventh lens L7. However, the number of lenses included in each lens group is not limited to the above example.

A diameter of a lens included in the second lens group G2 may be greater than a diameter of a lens included in the first lens group G1.

When each of the first lens group G1 and the second lens group G2 includes a plurality of lenses, the lens having the smallest diameter among the plurality of lenses of the second lens group G2 may have a diameter greater than a diameter of the lens having the largest diameter of the plurality of lenses of the first lens group G1.

For example, when the first lens group G1 includes the first to fifth lenses L1 to L5, the diameter of the fifth lens L5 may be the largest in the first lens group G1. When the second lens group G2 includes the sixth lens L6 and the seventh lens L7, the diameter of the sixth lens L6 may be the smallest in the second lens group G2.

The diameter of the sixth lens L6 may be larger than the diameter of the fifth lens L5.

The diameter of the lens included in the second lens group G2 may be 10 mm or greater.

In the lens included in the second lens group G2, a ratio between the thickest portion and the thinnest portion of the optical portion may be 3.0 or more. For example, T_max/T_min>3.0 may be satisfied. T_max refers to the greatest thickness of the optical portion, and T_min refers to the lowest thickness of the optical portion.

At least one of the lenses included in the first lens group G1 and the second lens group G2 may include an optical portion 10 and a flange portion 30.

When each of the first lens group G1 and the second lens group G2 includes a plurality of lenses, a distance between adjacent lenses in the first lens group G1 may be relatively narrow. The distance refers to the distance between the flange portions of adjacent lenses. The largest distance among the distances between adjacent lenses in the first lens group G1 may be defined as a first distance.

The distance between the first lens group G1 and the second lens group G2 may be relatively large. A distance between the first lens group G1 and the second lens group G2 may be defined as a second distance. The second distance may be larger than the first distance.

In the second lens group G2, a distance between adjacent lenses may be relatively large. The smallest distance among the distances between adjacent lenses may be defined as a third distance. In the example embodiment in FIG. 22, since the second lens group G2 includes the sixth lens L6 and the seventh lens L7, the distance between the sixth lens L6 and the seventh lens L7 may be a third distance. The third distance may be larger than the first distance.

However, an example embodiment thereof is not limited thereto, and at least one of the second distance and the third distance may be narrower than the first distance according to an optical design of the lens assembly.

A spacer SP may be provided between the lenses adjacent to each other. At least a portion of the flange portion of each lens may be in contact with the spacer SP. The spacer SP may maintain the distance between the lenses and may block unnecessary light.

The spacer SP may include a light absorbing layer to block unnecessary light. The light absorbing layer may be a black film or black iron oxide.

When the first lens group G1 includes a plurality of lenses, a thickness of the spacer SP disposed between the plurality of lenses of the first lens group G1 may be relatively thin. The spacer SP disposed between the plurality of lenses of the first lens group G1 may be defined as a first spacer portion SP1. The thickness refers to the thickness in the optical axis direction.

A thickness of the spacer SP disposed between the first lens group G1 and the second lens group G2 may be relatively thick. The spacer SP disposed between the first lens group G1 and the second lens group G2 may be defined as a second spacer portion SP2. A thickness of the second spacer portion SP2 may be greater than that of the first spacer portion SP1.

When the second lens group G2 includes a plurality of lenses, a thickness of the spacer SP disposed between the plurality of lenses of the second lens group G2 may be relatively thick. The spacer SP disposed between the plurality of lenses of the second lens group G2 may be defined as a third spacer portion SP3.

A thickness of the third spacer portion SP3 may be greater than that of the first spacer portion SP1.

However, an example embodiment thereof is not limited thereto, and a thickness of at least one of the second spacer portion SP2 and the third spacer portion SP3 may be smaller than the thickness of the first spacer portion SP1 according to an optical design of the lens assembly.

The lenses included in the first lens group G1 and the lenses included in the second lens group G2 may be manufactured by different methods. For example, at least one of the lenses of the first lens group G1 may be manufactured by injection molding, and at least one of the lenses of the second lens group G2 may be manufactured by the pressing method described with reference to FIGS. 1 to 18.

The lenses included in the first lens group G1 and the lenses included in the second lens group G2 may have different shapes.

For example, a lens included in the second lens group G2 may have a circular planar shape, and a lens included in the first lens group G1 may have a non-circular planar shape. Since the lens included in the first lens group G1 is manufactured by injection molding, it may be necessary to remove a gate, a passage of molten resin, and accordingly, the lens included in the first lens group G1 may have a non-circular shape, a portion of the side surface of which is cut out.

The lens included in the second lens group G2 may be provided with a protrusion 50 on an edge of the flange portion 30. The configuration of the protrusion 50 may be the same as described with reference to FIGS. 17 to 21.

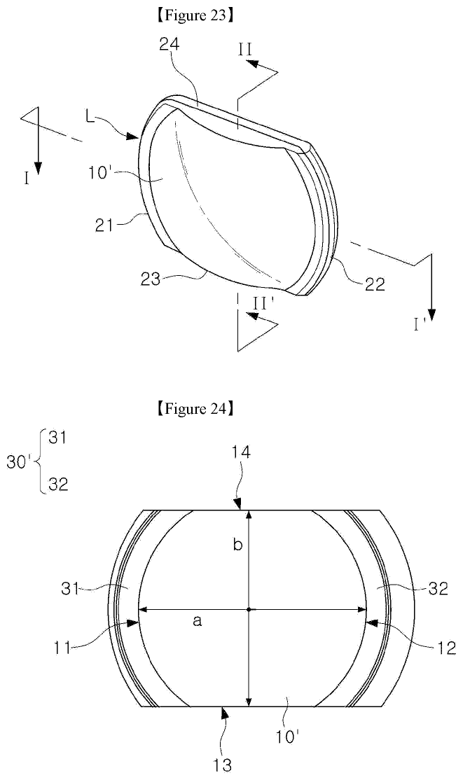

FIG. 23 is a perspective diagram illustrating a lens according to another example embodiment. FIG. 24 is a plan diagram illustrating a lens according to another example embodiment.

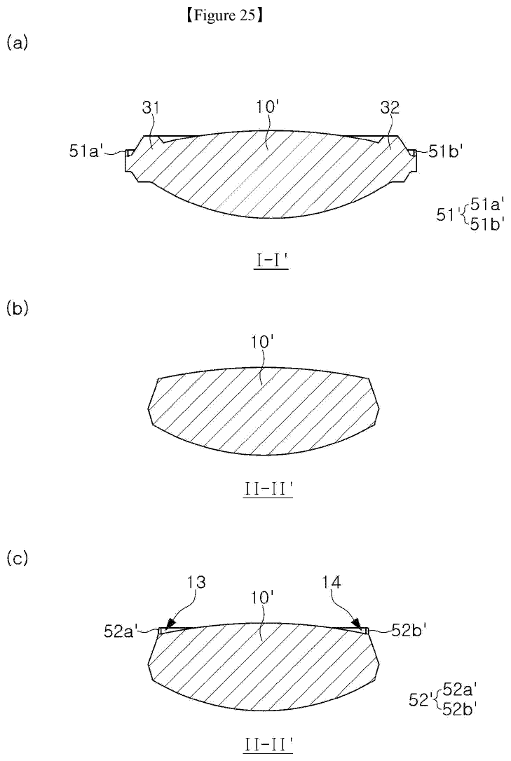

FIG. 25A is a cross-sectional diagram taken along line I-I′ in FIG. 23, FIG. 25B is a cross-sectional diagram taken along line II-II′ in FIG. 23, and FIG. 25C is a diagram illustrating a modified example of the example illustrated in FIG. 25B.

Referring to FIGS. 23 to 25, the lens L according to another example embodiment may have a non-circular planar shape. For example, the lens L may include a first side surface 21, a second side surface 22, a third side surface 23 and a fourth side surface 24. The first side surface 21 and the second side surface 22 may be disposed on opposite sides with reference to the optical axis, and the third side surface 23 and the fourth side surface 24 may be disposed on opposite sides with reference to the optical axis. The third side surface 23 and the fourth side surface 24 may connect the first side surface 21 and the second side surface 22.

When viewed in the optical axis direction, the first side surface 21 and the second side surface 22 of the lens L may have an arc shape, and the third side surface 23 and the fourth side surface 24 may have almost a linear shape.

The third side surface 23 and the fourth side surface 24 may connect the first side surface 21 and the second side surface 22. Also, the third side surface 23 and the fourth side surface 24 may be symmetrical about the optical axis and may be disposed parallel to each other.

A length of one of axes of the lens L, intersecting the optical axis and perpendicular to each other, may be longer than a length of the other axis.

The lens L may have a first axis and a second axis crossing the optical axis. For example, the first axis may connect the first side surface 21 and the second side surface 22 while passing through the optical axis, and the second axis may connect the third side surface 23 and the fourth side surface 24 while passing through the optical axis. The first axis and the second axis may be perpendicular to each other, and the length of the first axis may be longer than the length of the second axis.

The lens L may include an optical portion 10′ and a flange portion 30′.

The optical portion 10′ may exhibit the optical performance of the lens L. For example, light reflected from a subject may pass through the optical portion 10′ and may be refracted.

The optical portion 10′ may have refractive power and may have an aspherical shape.

Also, the optical portion 10′ may include an object-side surface (a surface directed to an object side) and an image-side surface (a surface directed to an image side).

The flange portion 30′ may fasten the lens L to another element, a lens barrel or another lens, for example.

The flange portion 30′ may extend from a circumference of at least a portion of the optical portion 10′, and may be integrated with the optical portion 10′.

The optical portion 10′ and the flange portion 30′ may have a non-circular shape. For example, the optical portion 10′ and the flange portion 30′ may have a non-circular shape when viewed from the optical axis direction. Differently from the above example, the optical portion 10′ may have a circular shape and the flange portion 30′ may have a non-circular shape.

The optical portion 10′ may include a first edge 11, a second edge 12, a third edge 13 and a fourth edge 14, the first edge 11 and the second edge 12 may oppose each other, and the third edge 13 and the fourth edge 14 may oppose each other.

The third edge 13 and the fourth edge 14 may connect the first edge 11 and the second edge 12.

The first edge 11 and the second edge 12 may be disposed on opposite sides with respect to the optical axis, and the third edge 13 and the fourth edge 14 may be disposed on opposite sides with respect to the optical axis.

When viewed from the optical axis direction, the first edge 11 and the second edge 12 may have an arc shape, and the third edge 13 and the fourth edge 14 have an almost linear shape. The third edge 13 and the fourth edge 14 may be symmetrical about the optical axis (Z axis) and may be disposed parallel to each other.

The shortest distance passing through the optical axis (Z axis) between the first edge 11 and the second edge 12 may be longer than the shortest distance passing through the optical axis (Z axis) between the third edge 13 and the fourth edge 14.

The optical portion 10′ may have a major axis a and a minor axis b. For example, when viewed from the optical axis direction, the line segment passing through the optical axis and connecting the third edge 13 to the fourth edge 14 with the shortest distance may be the short axis b, and the line segment passing through the optical axis, connecting the first edge 11 to the second edge 12, and perpendicular to the minor axis b may be the major axis a.

The length of the major axis a may be longer than the length of the minor axis b.

The flange portion 30′ may include a first flange portion 31 and a second flange portion 32, the first flange portion 31 may extend from the first edge 11 of the optical portion 10′, and the second flange portion 32 may extend from the second edge 12 of the optical portion 10′.

The first edge 11 of the optical portion 10′ may refer to a portion adjacent to the first flange portion 31, and the second edge 12 of the optical portion 10′ may refer to a portion adjacent to the second flange portion 32.

The third edge 13 of the optical portion 10′ may refer to one side of the optical portion 10′ in which the flange portion 30′ is not formed, and the fourth edge 14 of the optical portion 10′ may refer to an other side of the optical portion 10′ in which the flange portion 30′ is not formed.

The first side surface 21 of the lens L may refer to the side surface of the first flange portion 31, and the second side surface 22 may refer to the side surface of the second flange portion 32. Also, the third side surface 23 may refer to a side surface of the third edge 13 of the optical portion 10′, and the fourth side surface 24 may refer to the side surface of the fourth edge 14 of the optical portion 10′.

The lens L may be formed of a plastic material, and may be molded through the pressing method described with reference to FIGS. 1 to 18.

Since the lens L according to the example embodiment is molded by pressing the lens preform 1, the size of the lens L may be reduced and performance of the lens L may be ensured.

A protrusion may be disposed on at least one of the optical portion 10′ and the flange portion 30′. For example, the protrusion may include at least one of a first protrusion 51′ protruding from the flange portion 30′ and a second protrusion 52′ protruding from the optical portion 10′.

A first protrusion 51′ may be disposed on one surface of the flange portion 30′. The one surface of the flange portion 30′ may be an object-side surface or an image-side surface of the flange portion 30′.

The first protrusion 51′ may include a third protrusion 51a′ and a fourth protrusion 51b′. For example, the third protrusion 51a′ may be disposed on an edge of one surface of the first flange portion 31, and the fourth protrusion 51b′ may be disposed on an edge of one surface of the second flange portion 32. The third protrusion 51a′ and the fourth protrusion 51b′ may extend in the optical axis direction.

The first protrusion 51′ may be continuously disposed on the edge of the first flange portion 31 and the edge of the second flange portion 32 along the circumferential direction. Accordingly, the circumferences of the first flange portion 31 and the third protrusion 51a′ may be the same, and the circumferences of the second flange portion 32 and the fourth protrusion 51b′ may be the same.

However, an example embodiment thereof is not limited thereto, the lengths of the third protrusion 51a′ and the fourth protrusion 51b′ may be smaller than the circumferences of the first flange portion 31 and the second flange portion 32.

The first protrusion 51′ and the flange 30′ may have surfaces disposed on the same plane. For example, the side surface of the third protrusion 51a′ and the side surface of the first flange portion 31 may be disposed on the same plane. Also, the side surface of the fourth protrusion 51b′ and the side surface of the second flange portion 32 may be disposed on the same plane. Accordingly, the side surface of the first protrusion 51′ and the side surface of the flange portion 30′ may be continuously disposed.

Each of the third protrusion 51a′ and the fourth protrusion 51b′ have a length in the optical axis direction, and may have a width in a direction perpendicular to the optical axis.

Each protrusion may have a length of 100 μm or less and a width of 80 μm or less. The length and width may be configured as above to prevent each protrusion from interfering with the other components when the lens L is assembled to the lens barrel.

The width of each protrusion may increase or decrease along the circumference of the lens L.

The second protrusion 52′ may be disposed on one surface of the optical portion 10′. The one surface of the optical portion 10′ may be an object-side surface or an image-side surface of the optical portion 10′.

The second protrusion 52′ may include a fifth protrusion 52a′ and a sixth protrusion 52b′. For example, the fifth protrusion 52a′ may be disposed on the third edge 13 of the optical portion 10′, and the sixth protrusion 52b′ may be disposed on the fourth edge 14 of the optical portion 10′. The fifth protrusion 52a′ and the sixth protrusion 52b′ may extend in the optical axis direction.

The second protrusion 52′ may be continuously disposed along the third edge 13 and the fourth edge 14. Accordingly, the length of the third edge 13 and the length of the fifth protrusion 52a′ may be the same, and the length of the fourth edge 14 and the length of the sixth protrusion 52b′ may be the same.

However, an example embodiment thereof is not limited thereto, and the lengths of the fifth protrusion 52a′ and the sixth protrusion 52b′ may be smaller than the length of the third edge 13 and the length of the fourth edge 14, respectively.

The second protrusion 52′ and the optical portion 10′ may have surfaces lying on the same plane. For example, the side surface of the fifth protrusion 52a′ and the third side surface 23 of the lens L may be disposed on the same plane. Also, the side surface of the sixth protrusion 52b′ and the fourth side surface 24 of the lens L may be disposed on the same plane. Accordingly, the side surface of the second protrusion 52′ and the side surface of the optical portion 10′ may be continuously disposed.

Each of the fifth protrusion 52a′ and the sixth protrusion 52b′ may have a length in the optical axis direction and a width in a direction perpendicular to the optical axis.

The length of each protrusion may be 100 μm or less, and the width may be 80 μm or less. The length and the width may be configured as above to prevent each protrusion from interfering with the other components when the lens is assembled to the lens barrel.

The width of each protrusion may increase or decrease along the circumference of the lens L.

In another example embodiment, the first protrusion 51′ may extend in a direction perpendicular to the optical axis from one surface of the flange portion 30′, and the second protrusion 52′ may extend in a direction perpendicular to the optical axis from one surface of the optical portion 10′. One surface of the flange portion 30′ may be a side surface of the flange portion 30′, and one surface of the optical portion 10′ may be a side surface of the optical portion 10′.

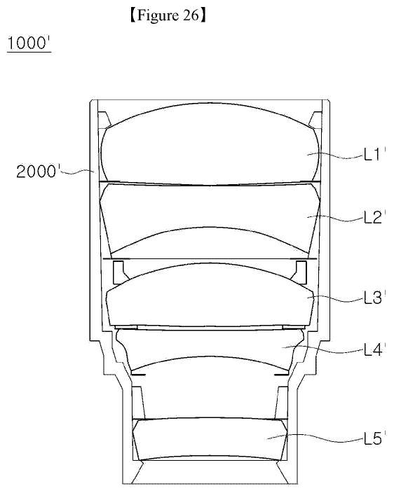

FIG. 26 is a cross-sectional diagram illustrating a lens assembly according to another example embodiment.

FIG. 26 is a cross-sectional diagram taken along line II-II′ as in FIG. 25B.

Referring to FIG. 26, a lens assembly 1000′ according to another example embodiment may include a plurality of lenses and a lens barrel 2000′.

The plurality of lenses may include a first lens L1′, a second lens L2′, a third lens L3′, a fourth lens L4′, and a fifth lens L5′.

The first lens L1′ refers to a lens most adjacent to an object side among the plurality of lenses. The fifth lens L5′ refers to a lens most adjacent to an image side among the plurality of lenses.

In the example embodiment, the plurality of lenses may include five lenses, but an example embodiment thereof is not limited thereto. The number of lenses may be determined according to performance of the lens assembly.

Each of the plurality of lenses may include an optical portion and a flange portion. Among the diameters of the optical portions of the lenses, the diameter of the optical portion of the first lens L1′ may be the largest, and the diameter of the optical portion of the fifth lens L5′ may be the smallest.

A ratio of the diameter of the optical portion of the fifth lens L5′ to the diameter of the optical portion of the first lens L1′ may be less than 0.7. For example, ED5/ED1<0.7 may be satisfied. ED1 is the diameter of the optical portion of the first lens L1′, and ED5 is the diameter of the optical portion of the fifth lens L5′.

The plurality of lenses may be accommodated in the lens barrel 2000′. For example, the first to fifth lenses L1′ to L5′ may be disposed in the lens barrel 2000′ along the optical axis.

At least one of the plurality of lenses may be a lens described with reference to FIGS. 23 to 25C, and may be manufactured by the pressing method described with reference to FIGS. 1 to 18.

However, an example embodiment thereof is not limited thereto, and all of the plurality of lenses may have the shape of the lens described with reference to FIGS. 23 to 25C, and may be manufactured by the pressing method described with reference to FIGS. 1 to 18.

When one of the plurality of lenses is a lens described with reference to FIGS. 23 to 25C, the lens may be the first lens L1′. Also, when two of the plurality of lenses are lenses described with reference to FIGS. 23 to 25C, the lenses may be the first lens L1′ and the second lens L2′.

According to the aforementioned example embodiments, by using the plastic lens, a method for manufacturing the plastic lens, and a molding apparatus for manufacturing the plastic lens according to the example embodiments, optical performance of the lens may be improved.

While specific example embodiments have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. A method of manufacturing a plastic lens, the method comprising:
first heating of a lens preform;
disposing the lens preform in a molding apparatus;
second heating of the lens preform;
pressing the lens preform with the molding apparatus; and
cooling the molding apparatus.

2. The method of claim 1, wherein the first heating of the lens preform comprises:
moving the lens preform; and
heating the lens preform to a temperature within a first temperature range.

3. The method of claim 2, wherein the temperature within the first temperature range is equal to or lower than a glass transition temperature of the lens preform.

4. The method of claim 3, wherein the temperature within the first temperature range is Tg−50° C. to Tg, where Tg is the glass transition temperature of the lens preform.

5. The method of claim 2, wherein the lens preform is heated to the temperature within the first temperature range while moving to the molding apparatus.

6. The method of claim 2, wherein the lens preform is moved to the molding apparatus while being adsorbed and heated by a moving device comprising an adsorption portion and a heating portion.

7. The method of claim 2, wherein the first heating of the lens preform further comprises seating the lens preform in a preheating stage and heating the lens preform before the lens preform is disposed in the molding apparatus.

8. The method of claim 1,
wherein the disposing the lens preform in the molding apparatus comprises seating the lens preform in a molding portion of the molding apparatus, and
wherein the molding apparatus is heated to a temperature within a first temperature range.

9. The method of claim 1, wherein the second heating of the lens preform comprises:
forming a cavity in which the lens preform is disposed by combining a first molding apparatus and a second molding apparatus of the molding apparatus; and
heating the molding apparatus to a temperature within a second temperature range.

10. The method of claim 9, wherein the temperature within the second temperature range is equal to or higher than the glass transition temperature of the lens preform.

11. The method of claim 10, wherein the temperature within the second temperature range is Tg to Tg+100° C., where Tg is the glass transition temperature of the lens preform.

12. The method of claim 9, wherein the heating the molding apparatus to the temperature within the second temperature range comprises increasing the temperature of the lens preform to be higher than the first heating temperature by heating the molding apparatus.

13. The method of claim 9, wherein the heating the molding apparatus to the temperature within the second temperature range comprises further increasing a temperature of the cavity to be higher than a temperature of an other portion of the molding apparatus.

14. The method of claim 9, wherein the heating the molding apparatus to the temperature within the second temperature range includes heating a pin core of the first molding apparatus and a pin core of the second molding apparatus which form the cavity, through a heating portion disposed in the molding apparatus.

15. The method of claim 14, wherein the heating portion comprises a heating wire, and the method further comprises applying power to the heating wire.

16. The method of claim 1, wherein, in the pressing the lens preform with the molding apparatus, when a temperature of the lens preform is equal to or higher than the glass transition temperature, the lens preform is pressed.

17. The method of claim 1, wherein, in the pressing the lens preform with the molding apparatus, the lens preform is pressed while being heated to a temperature within a second temperature range equal to or higher than the glass transition temperature of the lens preform.

18. The method of claim 1, wherein, in the cooling the molding apparatus, the molding apparatus is cooled to a temperature less than the glass transition temperature of the lens preform.

19. The method of claim 1, wherein the cooling the molding apparatus includes supplying a fluid to the molding apparatus.

20. The method of claim 1, further comprising:
preparing the lens preform,
wherein the lens preform is formed to have a shape different from a shape of a cavity of the molding apparatus.

21. The method of claim 20, wherein the preparing the lens preform comprises injection molding the lens preform using a thermoplastic resin.

22. The method of claim 20, wherein the preparing the lens preform comprises applying heat to a thermoplastic resin in a pellet state and pressing the thermoplastic resin.

23. The method of claim 20, wherein the preparing the lens preform comprises drying a thermoplastic resin in a pellet state by freezing the thermoplastic resin, powdering the thermoplastic resin by pulverizing the thermoplastic resin, and pressing the powdered thermoplastic resin.

24. The method of claim 20, wherein the preparing the lens preform comprises laminating and pressing a plurality of films or sheets of a thermoplastic resin material.

25. A molding apparatus for molding a plastic lens, the molding apparatus comprising:
a first molding apparatus including a first core portion and a first body portion accommodating the first core portion; and
a second molding apparatus including a second core portion and a second body portion accommodating the second core portion,
wherein the first molding apparatus and the second molding apparatus oppose each other, and one of the first molding apparatus and the second molding apparatus is configured to be movable,
wherein each of the first core portion and the second core portion includes at least one pin core having a molding portion corresponding to a shape of a lens to be manufactured, and
wherein each of the first body portion and the second body portion includes a heating portion configured to generate heat and a flow path portion configured to be provided with a fluid.

26. The molding apparatus of claim 25,
wherein the heating portion includes a first heating portion for heating the first body portion and the second body portion, and
wherein the first heating portion includes an accommodating portion penetrating one side of the first body portion and the second body portion, and a heating member disposed in the accommodating portion.

27. The molding apparatus of claim 26,
wherein the heating member comprises:
a conductive housing;
an insulating core disposed in the conductive housing; and
a wound coil disposed on the insulating core, and
wherein the wound coil has a region in which a winding space is narrower than that of an other region.

28. The molding apparatus of claim 26, wherein the accommodating portion and the flow path portion are connected to each other.

29. The molding apparatus of claim 28,
wherein the accommodating portion has a length in one direction, and
wherein the flow path portion has a length in an other direction intersecting the accommodating portion.

30. The molding apparatus of claim 28,
wherein the flow path portion comprises:
a first flow path connected to one side of the accommodating portion; and
a second flow path connected to an other side of the accommodating portion,
wherein the first flow path is connected to the second flow path by the accommodating portion.

31. The molding apparatus of claim 30,
wherein the first flow path has one side configured to be opened and closed, and an other side to be closed,
wherein the second flow path has the one side closed, and the other side configured to be opened and closed, and
wherein one of the one side of the first flow path and the other side of the second flow path is an inlet configured to flow the fluid in, and the other is an outlet configured to discharge the fluid.

32. The molding apparatus of claim 31, wherein a direction in which the fluid is configured to flow in the first body portion is opposite to a direction in which the fluid is configured to flow in the second body portion.

33. The molding apparatus of claim 25,
wherein the heating portion comprises a first heating portion for heating the first body portion and the second body portion, and
wherein the first heating portion comprises:
a coil portion; and
a plate spaced apart from the coil portion and having conductivity.

34. The molding apparatus of claim 25, wherein the heating portion comprises a first heating portion for heating the first body portion and the second body portion, and a second heating portion for heating the first core portion and the second core portion.

35. The molding apparatus of claim 34, wherein a heating temperature of the second heating portion is higher than a heating temperature of the first heating portion.

36. The molding apparatus of claim 35, wherein a heating temperature of the first heating portion is equal to or less than a glass transition temperature of a material of the lens to be manufactured, and a heating temperature of the second heating portion is equal to or higher than the glass transition temperature.

37. The molding apparatus of claim 36,
wherein a heating temperature of the first heating portion is from a temperature lower than the glass transition temperature by 50° C. to the glass transition temperature, and
wherein a heating temperature of the second heating portion is from the glass transition temperature to a temperature higher than the glass transition temperature by 100° C.

38. The molding apparatus of claim 34, wherein the second heating portion comprises a heating wire disposed around the first core portion and around the second core portion.

39. The molding apparatus of claim 38,
wherein each of the first core portion and the second core portion comprises a plurality of pin cores, and
wherein the heating wire includes a plurality of heating wires corresponding to the pin cores, respectively.

40. A plastic lens, comprising:
an optical portion refracting light; and
a flange portion extending from a circumference of the optical portion,
wherein the flange portion includes a protrusion protruding from one surface of the flange portion, and
wherein T_max/T_min>3.0 is satisfied, where T_max is a greatest thickness of the optical portion, and T_min is a lowest thickness of the optical portion.

41. The plastic lens of claim 40, wherein a diameter of the plastic lens is 10 mm or greater.

42. The plastic lens of claim 40, wherein the protrusion extends in an optical axis direction from an edge of one surface of the flange portion.

43. The plastic lens of claim 42,
wherein a length of the protrusion in the optical axis direction is 100 μm or less, and
wherein a width of the protrusion in a direction perpendicular to the optical axis is 80 μm or less.

44. The plastic lens of claim 42, wherein a width of the protrusion in a direction perpendicular to the optical axis changes in a circumferential direction.

45. The plastic lens of claim 40, wherein the protrusion is continuously disposed along the circumferential direction on the edge of the one surface of the flange portion.

46. The plastic lens of claim 40,
wherein the protrusion includes a plurality of protrusions spaced apart from each other, and
wherein a sum of circumferences of the plurality of protrusions in the circumferential direction is 80% or greater of a circumference of the flange portion.

47. The plastic lens of claim 40, wherein the protrusion extends in a direction perpendicular to an optical axis from one surface of the flange portion.

48. A lens assembly, comprising:
a lens barrel comprising an inner space to accommodate one or more lenses, and openings configured to pass light;
one or more lenses disposed in the inner space along an optical axis configured to receive incident light and emit refracted light,
wherein the one or more lenses comprise the plastic lens of claim 40, and
wherein the one or more lenses comprise a first group disposed toward an object side and a second group disposed toward an image side of the lens barrel.

49. A plastic lens, comprising:
an optical portion refracting light;
a flange portion extending from a circumference of the optical portion; and
a protrusion protruding from at least one of the optical portion and the flange portion,
wherein the optical portion comprises:
a first edge and a second edge disposed on opposite sides with reference to an optical axis and including an arc shape; and
a third edge and a fourth edge connecting the first edge to the second edge, and disposed on opposite sides with reference to the optical axis,
wherein a shortest distance passing through the optical axis between the third edge and the fourth edge is shorter than a shortest distance passing through the optical axis between the first edge and the second edge, and
wherein the flange portion includes a first flange portion extending from the first edge and a second flange portion extending from the second edge.

50. The plastic lens of claim 49, wherein the protrusion protrudes from one surface of the first flange portion and one surface of the second flange portion.

51. The plastic lens of claim 49, wherein the protrusion protrudes from the third edge and the fourth edge.

52. A lens assembly comprising:
a lens barrel comprising an inner space to accommodate one or more lenses, and openings configured to pass light;
one or more lenses disposed in the inner space along an optical axis configured to receive incident light and emit refracted light,
wherein the one or more lenses comprise the plastic lens of claim 48 secured to one or more of the lens barrel and another lens by the flange portion.

53. A method of manufacturing a lens comprising:
heating a lens preform to a first temperature;
disposing the lens preform heated to the first temperature in a molding apparatus;
heating the lens preform to a second temperature in the molding apparatus;
pressing the lens preform heated to the second temperature into a lens; and
cooling the molding apparatus.

54. The method of claim 53, further comprising moving the lens preform,
wherein the first temperature is in a range between 50° C. below a glass transition temperature of the lens preform and the glass transition temperature of the lens preform.

55. The method of claim 54, wherein the lens preform is heated to the first temperature while moving the lens preform to the molding apparatus.

56. The method of claim 53, wherein the disposing the lens preform in the molding apparatus comprises disposing the lens preform in a cavity between a first molding apparatus and a second molding apparatus of the molding apparatus, and
wherein heating the lens preform to the second temperature comprises heating the molding apparatus to a temperature within a range between the glass transition temperature of the lens preform and 100° C. above the glass transition temperature.

57. The method of claim 53, wherein the heating the lens preform to the second temperature in the molding apparatus comprises locally heating the molding apparatus adjacent the lens preform to a temperature within a range between the glass transition temperature of the lens preform and 100° C. above the glass transition temperature and independently generally heating the molding apparatus.

58. The method of claim 53, wherein
the heating the lens preform to the first temperature comprises heating a plurality of lens preforms to the first temperature,
the disposing the lens preform heated to the first temperature in the molding apparatus comprises disposing the plurality of lens preforms heated to the first temperature in the molding apparatus,
the heating the lens preform to the second temperature in the molding apparatus comprises heating the plurality of lens preforms to the second temperature, and
the pressing the lens preform heated to the second temperature into the lens comprises pressing the plurality of lens preforms heated to the second temperature into a plurality of lenses at the same time.

59. A molding apparatus for molding a lens comprising:
a first molding apparatus comprising one or more first molding portions corresponding to a shape of a lens to be manufactured;
a second molding apparatus comprising one or more second molding portions corresponding to a shape of a lens to be manufactured opposing the first molding portions and configured to be movable;
wherein each of the first molding apparatus and the second molding apparatus comprises a heating portion configured to generate heat and a flow path portion configured to flow a fluid.

60. The molding apparatus of claim 59, wherein the first molding apparatus comprises a first core portion comprising one or more pin cores having the first molding portion and a first body portion accommodating the first core portion, and
wherein the second molding apparatus comprises a second core portion comprising one or more pin cores having the second molding portion and a second body portion accommodating the first core portion.

61. The molding apparatus of claim 59, wherein the heating portion comprises an accommodating portion penetrating sides of the first molding apparatus and the second molding apparatus, and a heating member disposed in the accommodating portion.

62. A pressed lens, comprising:
an optical portion configured to refract light;
a flange portion extending from an outer periphery of the optical portion; and
a pressed protrusion protruding from one of the flange portion and the optical portion,
wherein the pressed protrusion extends in one of parallel to an optical axis direction of the optical portion and perpendicular to the optical axis direction.

63. The lens of claim 62, wherein the pressed lens is substantially free of flow mark, weld line, and birefringence.

64. The lens of claim 62, wherein T_max/T_min>3.0, where T_max is a greatest thickness of the optical portion, and T_min is a lowest thickness of the optical portion.

65. The lens of claim 62, wherein the optical portion comprises:
a first edge and a second edge disposed on opposite sides with reference to an optical axis and each comprising an arc shape; and
a third edge and a fourth edge connecting the first edge to the second edge, and disposed on opposite sides with reference to the optical axis,
wherein a shortest distance passing through the optical axis between the third edge and the fourth edge is shorter than a shortest distance passing through the optical axis between the first edge and the second edge, and
wherein the flange portion comprises a first flange portion extending from the first edge and a second flange portion extending from the second edge.

66. A lens assembly comprising:
a lens barrel comprising an inner space to accommodate one or more lenses, and openings configured to pass light; and
one or more lenses disposed in the inner space along an optical axis configured to receive incident light and emit refracted light,
wherein the one or more lenses comprise the lens of claim 62.
